(19) United States
(12) Patent Application Publication
(10) Pub. No.: US 2016/0006839 A1
(43) Pub. Date: Jan. 7, 2016

(54) DATA COLLECTION AND DISTRIBUTION METHOD, DATA COLLECTION AND DISTRIBUTION APPARATUS, AND PROGRAM

(71) Applicant: HITACHI, LTD., Chiyoda-ku, Tokyo (JP)

(72) Inventors: Junya SAWAZAKI, Tokyo (JP); Atsushi HIRATA, Tokyo (JP); Yoshitaka SATOU, Tokyo (JP)

(21) Appl. No.: 14/770,955

(22) PCT Filed: Dec. 25, 2013
(86) PCT No.: PCT/JP2013/084558

§ 371 Date: Aug. 27, 2015

(51) Int. Cl. H04L 29/06; H04L 29/08

(52) U.S. Cl. CPC H04L 67/42; H04L 67/10

(57) ABSTRACT

Proposed are a data collection and distribution method, a data collection and distribution apparatus and a program which enable the convenience of a data provider to be improved. A data collection and distribution apparatus, which acquires and stores collected data collected by a data collection client and distributes the collected data to a data destination client, determines whether or not an attribute of the collected data collected from the data collection client is at variance with an attribute according to a prior arrangement, determines a collected data processing method based on a determination result, and selectively distributes the collected data of the attribute according to the prior arrangement to the data destination client based on a determination result.

### TECHNICAL FIELD

The present invention relates to a data collection and distribution method, a data collection and distribution apparatus, and a program and, more particularly, is suitably applied to a data collection and distribution system which sends and receives data in a format according to a prior arrangement between a data supplier and a data exchange intermediary, and between a data exchange intermediary and a data user.

### BACKGROUND ART

In recent years, businesses which use data produced by so-called M2M (Machine To Machine) devices such as, for example, electric meters in the home, as well as sensor devices which are installed on-site or in machines, which are each connected to a network, have been attracting a lot of attention. M2M devices are able to communicate directly without the need for human intervention and therefore a novel value can be provided by collecting data produced by M2M devices and by monitoring and managing the M2M devices.

When using data produced by M2M devices, a variety of data-exchange related arrangements must be made beforehand between three parties, namely, a data provider providing the data, a data user using the data, and a data exchange intermediary which mediates between the data provider and data user, such as, on the data provider side, a data collection method and a format for transferring the collected data to a data exchange intermediary, and, on the data exchange intermediary side, a data storage method and a distribution format for distributing the stored data to a data user. Well-known examples in this type of technical field include the patent literature below:

### CITATION LIST

### Patent Literature

[PTL 1] Japanese Patent Publication No. 3683839
[PTL 2] Japanese Patent Application Laid-open No. H10-27119

### SUMMARY OF INVENTION

### Technical Problem

Incidentally, cases may be considered where, after having concluded various data exchange-related arrangements between a data provider and data exchange intermediary as described above, data is transmitted to the data exchange intermediary in a format or the like which differs from a prior arrangement at the convenience of the data provider (M2M devices). The following cases are relevant with regard to the above ‘cases where collected data in a format or the like which differs from a prior arrangement is transmitted to the data exchange intermediary.’

1. A case where the collected data format is changed due to a device update
2. A case where a data collection test is performed using a test device.

These two cases both involve a situation where data in a format or the like according to the prior arrangement and data in a format which differs from the prior arrangement must inevitably be mixed together simultaneously, and therefore the problem has been that the two sets of data are mixed in an existing system and stored in a data exchange intermediary, whereby the data in a format which differs from the prior arrangement is also distributed to the data user.

As a method for dealing with this problem, a method may be considered in which M2M device updates are matched with the timings for conducting data collection tests, in order to prevent the data in a format or the like according to the prior arrangement from being simultaneously mixed with data in a format which differs from the prior arrangement. However, M2M devices are normally geographically scattered and the timings for data collection with the M2M devices vary depending on the devices, thus making the foregoing method hard to implement.

Therefore, with regard to the data which is transmitted from the data provider to the data exchange intermediary, even in a case where the data in a format or the like according to the prior arrangement is mixed with data in a format which differs from the prior arrangement, as long as data can always be distributed by the data exchange intermediary to the data user in a format or the like according to the prior arrangement with the data user, M2M device updates and data collection tests can be freely carried out on the data provider side and this method may be regarded as improving the convenience of the data provider.

The present invention was conceived in view of the above points and proposes a data collection and distribution method, a data collection and distribution apparatus and a program which enable the convenience of a data provider to be improved.

### Solution to Problem

In order to solve this problem, the present invention provides a data collection and distribution method for a data collection and distribution apparatus which acquires and stores collected data collected by a data collection client and distributes the collected data to a data destination client, comprising a first step in which the data collection and distribution apparatus determines whether or not an attribute of the collected data collected from the data collection client is at variance with an attribute according to a prior arrangement, a second step in which the data collection and distribution apparatus determines a method for processing the collected data based on a determination result of the first step, and a third step in which the data collection and distribution apparatus selectively distributes the collected data of the attribute according to the prior arrangement to the data destination client based on a determination result of the second step.

Furthermore, the present invention provides a data collection and distribution apparatus which acquires and stores collected data collected by a data collection client and distributes the collected data to a data destination client, comprising a collected data attribute variance determination unit which determines whether or not an attribute of the collected data collected from the data collection client is at variance with an attribute according to a prior arrangement, a collected data processing method determination unit which determines a method for processing the collected data based on a result of the determination by the collected data attribute variance determination unit, and a collected data processing unit which selectively distributes the collected data of the attribute according to the prior arrangement to the data destination client based on a result of the determination by the collected data processing method determination unit.

Moreover, the present invention is a program executed by a data collection and distribution apparatus which acquires and stores collected data collected by a data collection client and distributes the collected data to a data destination client, the program causing the data collection and distribution apparatus to execute processing comprising a first step of determining whether or not an attribute of the collected data collected from the data collection client is at variance with an attribute according to a prior arrangement, a second step of determining a method for processing the collected data based on a determination result of the first step, and a third step of selectively distributing the collected data of the attribute according to the prior arrangement to the data destination client based on a determination result of the second step.

With the data collection and distribution method, data collection and distribution apparatus and a program according to the present invention, because the data provider, which operates a data collection client, carries out updates to the data collection client and data collection tests and so forth, the distribution of distributed data, which is in a format or the like that differs from the ‘prior arrangement,’ from the data collection and distribution apparatus to the data destination client can be effectively prevented ahead of time.

### Advantageous Effects of Invention

The present invention makes it possible to realize a data collection and distribution method, a data collection and distribution apparatus and a program which enable a data provider to freely conduct updates to a data collection client and data collection tests at the convenience of the data provider, and which accordingly enable the convenience of the data provider to be improved.

### BRIEF DESCRIPTION OF DRAWINGS

FIG. 1 is a block diagram showing an overall configuration of a data collection and distribution system according to a first embodiment.

FIG. 2 is a conceptual view conceptually showing a configuration of a collected data attribute table.

FIG. 3 is a conceptual view conceptually showing a configuration of a variance determination condition definition table.

FIG. 4 is a conceptual view conceptually showing a configuration of a collected data processing method definition table.

FIG. 5 is a conceptual view conceptually showing a configuration of a collected data storage method recording table.

FIG. 6 is a conceptual view conceptually showing a configuration of a distributed data attribute table.

FIG. 7 is a flowchart showing a processing routine for data collection processing.

FIG. 8 is a flowchart showing a processing routine for collected data attribute variance determination processing.

FIG. 9 is a flowchart showing a processing routine for collected data processing method determination processing.

FIG. 10 is a flowchart showing a processing routine for collected data storage processing.

FIG. 11 is a flowchart showing a processing routine for data distribution processing.

FIG. 12 is a flowchart showing a processing routine for stored data retrieval processing.

FIG. 13 is a flowchart showing a processing routine for processing to process stored data.

FIG. 14 is a block diagram showing an overall configuration of a data collection and distribution system according to a second embodiment.

FIG. 15 is a conceptual view conceptually showing a configuration of a distributed data attribute table according to the second embodiment.

FIG. 16 is a flowchart showing a processing routine for collected data alternative storage notification processing.

FIG. 17 is a block diagram showing an overall configuration of a data collection and distribution system according to a third embodiment.

FIG. 18 is a conceptual view conceptually showing a configuration of an expanded distributed data attribute table.

FIG. 19 is a flowchart showing a processing routine for distributed data attribute generation processing.

FIG. 20 is a flowchart showing a processing routine for stored data retrieval processing according to the third embodiment.

FIG. 21 is a block diagram showing an overall configuration of a data collection and distribution system according to a fourth embodiment.

FIG. 22 is a conceptual view conceptually showing a configuration of a collected data attribute variance recording table according to the second embodiment.

FIG. 23 is a flowchart showing a processing routine for expanded stored data retrieval processing.

FIG. 24 is a flowchart showing a processing routine for processing to process expanded stored data.

FIG. 25 is a block diagram showing an overall configuration of a data collection and distribution system according to a fifth embodiment.

FIG. 26 is a conceptual view showing a configuration example of a collected data processing method definition table according to a fifth embodiment.

FIG. 27 is a flowchart showing a processing routine for collected data storage processing according to the fifth embodiment.

### DESCRIPTION OF EMBODIMENTS

### First Embodiment

### (1) First Embodiment

### (1-1) Configuration of Data Collection and Distribution System According to this Embodiment

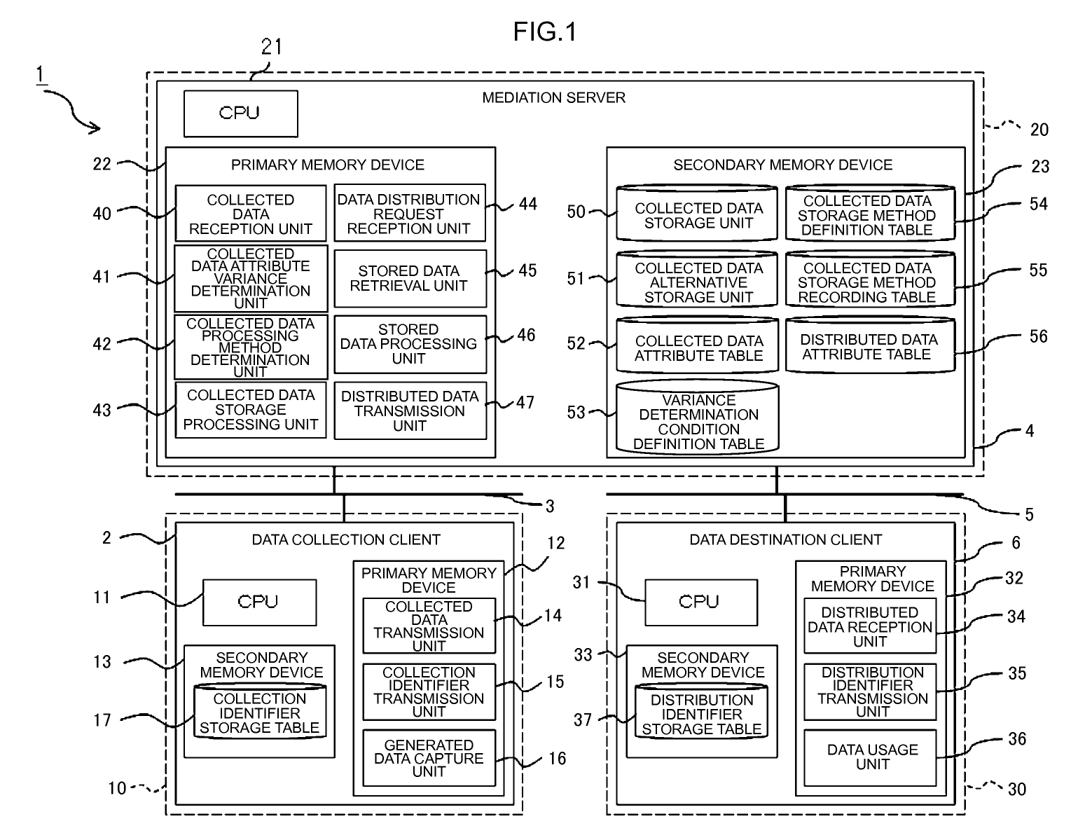

In FIG. 1, 1 indicates the whole data collection and distribution system according to this embodiment. This data collection and distribution system 1 is configured such that one or more data collection clients 2 are connected to a mediation server 4 via a first network 3, and the mediation server 4 is connected to one or more data destination clients 6 via a second network 5.

The data collection client 2 is an M2M device which is provided for a data provider 10 such as, for example, an electric meter installed in each home or a sensor device that is installed on-site or in a machine, and is configured comprising a CPU (Central Processing Unit) 11, a primary memory device 12 and a secondary memory device 13.

The CPU 11 is a processor which governs control of the operation of the whole data collection client 2. Further, the primary memory device 12 is configured, for example, from a volatile semiconductor memory and is used as a working memory of the CPU 11. Furthermore, the secondary memory device 13 is configured from a large-capacity, involatile memory device.

The data collection client 2 collects information such as operation information indicating device operating states such as the status of its own device or an external device (the presence or absence of faults, whether the device is operating or has stopped), performance information such as a CPU operating rate and memory utilization of its own device or an external device, or measurement values which are output from various sensors (not shown) in its own device or an external device, and error information consisting of fault information or the like, and so forth, and transmits this collected information to the mediation server 4 as collected data at regular intervals or with the collected timing.

As means for this purpose, the primary memory device 12 of the data collection client 2 stores a collected data transmission unit 14, a collection identifier transmission unit 15 and a generated data capture unit 16, and the secondary memory device 13 of the data collection client 2 stores a collection identifier storage table 17.

The collected data transmission unit 14 is a program comprising a function for transmitting information that has been collected as collected data. Further, the collection identifier transmission unit 15 is a program comprising a function which, when the collected data transmission unit 14 transmits collected data to the mediation server 4, transmits identifiers (hereinafter called ‘collection identifiers’) indicating attributes of the collected data (operation information, performance information and error information and the like, hereinafter called ‘collected data attributes’) according to a ‘prior arrangement’ between a data provider 10 and a data exchange intermediary 20 to the mediation server 4. Note that the collection identifier transmission unit 15 transmits these collection identifiers to the mediation server 4 by including these collection identifiers in the collected data. Further, the generated data capture unit 16 is a program comprising a function for collecting this information from an external device.

Furthermore, the collection identifier storage table 17 is a table which is used to store and manage a collection identifier for each collected data attribute according to the foregoing ‘prior arrangement.’ A collection identifier for each collected data attribute is pre-registered by the system administrator or the like in the collection identifier storage table 17.

The mediation server 4 is a server device which is installed by the data exchange intermediary 20 and comprises a function which stores the collected data transmitted from the data collection client 2 and distributes the stored collected data to the data destination client 6 of a data user 30 in a format according to a ‘prior arrangement’ between the data exchange intermediary 20 and the data user 30.

The mediation server 4 is configured comprising a CPU 21, a primary memory device 22 and a secondary memory device 23. The CPU 21, primary memory device 22 and secondary memory device 23 have the same functions as the corresponding parts of the data collection client 2 (the CPU 11, primary memory device 12, and secondary memory device 13) and a description thereof will therefore be omitted here.

The data destination client 6 is a computer device which is installed on the data user 30 side and comprises a function which uses distributed data transmitted from the mediation server 4 to execute predetermined processing (analysis or prediction, or the like, for example) according to the task of the data user 30.

This data destination client 6 is also configured comprising a CPU 31, primary memory device 32, and secondary memory device 33. The CPU 31, primary memory device 32, and secondary memory device 33 also comprise the same functions as the corresponding parts of the data collection client 2 and a description thereof will therefore be omitted here.

The primary memory device 32 of the data destination client 6 stores a distribution identifier transmission unit 34, a distributed data reception unit 35 and a data usage unit 36, and the secondary memory device 33 of the data destination client 6 stores a distribution identifier storage table 37.

Of these, the distribution identifier storage table 37 is a table which is used to store an identifier (hereinafter called a ‘distribution identifier’) for each attribute of distributed data (hereinafter called ‘distributed data attribute’) which is prescribed by the ‘prior arrangement’ between the data exchange intermediary 20 and the data user 30.

Further, the distribution identifier transmission unit 34 is a program comprising a function for reading distribution identifiers of the distributed data (collected data) for which distribution is desired from the distribution identifier storage table 37 and transmits a request to distribute the distributed data which comprises the distribution identifiers thus read (hereinafter called the ‘data distribution request’) to the mediation server 4.

In processing, the distributed data reception unit 35 is a program which comprises a function for receiving distributed data which is distributed from the mediation server 4 according to the data distribution request and the data usage unit 36 is an application program which executes the forgoing predetermined processing which uses the distributed data which has been distributed from the mediation server 4.

### (1-2) Data Collection and Distribution Function According to this Embodiment

### (1-2-1) Data Collection and Distribution Function According to this Embodiment

The data collection and distribution function according to this embodiment which is installed in the mediation server 4 will be described next. Note that, hereinbelow, the word ‘attribute’ where collected data is concerned is used to mean both the type of collected data content (operation information, performance information or error information, or the like) and the collected data format, source range and reception frequency, and the like. However, in order to prevent confusion, when ‘attribute’ is used as a word to mean the type of collected data, attribute will appear as ‘collected data attribute,’ and when ‘attribute’ is used as a word to indicate the format or the like of the collected data, attribute appears as ‘collected data attribute.’ Note that, ‘collected data attribute’ also appears as ‘collected data format or the like’ but both word forms have the same meaning.

In the case of the data collection and distribution system 1, installed on the mediation server 4 is a data collection and distribution function which monitors whether the format or the like of the collected data transmitted from each of the data collection clients 2 is the format or the like according to the ‘prior arrangement’ between the data provider 10 and data exchange intermediary 20, and selectively distributes only the collected data which is in the format or the like that corresponds to the ‘prior arrangement’ to the data destination client 6.

As means for realizing this data collection and distribution function according to this embodiment, the primary memory device 22 of the mediation server 4 stores a collected data reception unit 40, a collected data attribute variance determination unit 41, a collected data processing method determination unit 42, a collected data storage processing unit 43, a data distribution request reception unit 44, a stored data retrieval unit 45, a stored data processing unit 46, and a distributed data transmission unit 47, and the secondary memory device 23 of the mediation server 4 stores a collected data storage unit 50, a collected data alternative storage unit 51, a collected data attribute table 52, a variance determination condition definition table 53, a collected data storage method definition table 54, a collected data storage method recording table 55 and a distributed data attribute table 56.

The collected data reception unit 40 is a program comprising a function for receiving collected data which is being transmitted from each the data collection clients 2. Further, the collected data attribute variance determination unit 41 is a program comprising a function for specifying the collected data attributes of the collected data received by the collected data reception unit 40 and for determining whether or not the attributes of the collected data correspond to the ‘prior arrangement’ prescribed for the collected data attributes.

The collected data processing method determination unit 42 is a program comprising a function for determining the processing method (storage method) based on the result of the determination by the collected data attribute variance determination unit 41 for the collected data received by the collected data reception unit 40. Further, the collected data storage processing unit 43 is a program comprising a function for storing the collected data received by the collected data reception unit 40 in the collected data storage unit 50 or the collected data alternative storage unit 51 in the secondary memory device 23 by means of a storage method based on the result of the determination by the collected data processing method determination unit 42.

Furthermore, the data distribution request reception unit 44 is a program comprising a function for receiving and processing a data distribution request which is transmitted from the data destination client 6 and the stored data retrieval unit 45 is a program comprising a function for retrieving (reading) the corresponding collected data stored in the collected data storage unit 50 in response to a data distribution request from the data destination client 6.

In addition, the stored data processing unit 46 is a program comprising a function for executing processing to process the collected data retrieved from the collected data storage unit 50 by the stored data retrieval unit 45 so that the collected data is converted to a format (data length, data order, data content, and the like) according to the ‘prior arrangement’ between the data exchange intermediary 20 and the data user 30, and the distributed data transmission unit 47 is a program comprising a function for distributing the collected data processed by the stored data processing unit 46 as distributed data to the data destination client 6 which was the source of the foregoing data distribution request.

Meanwhile, the collected data storage unit 50 is a memory region for storing the collected data in a case where a collected data attribute transmitted from the data collection client 2 is in a format according to the ‘prior arrangement’ with the data provider 10 and the collected data alternative storage unit 51 is a memory region for storing the collected data in a case where the format or the like of the collected data transmitted from the data collection client 2 differs from the ‘prior arrangement’ with the data provider 10.

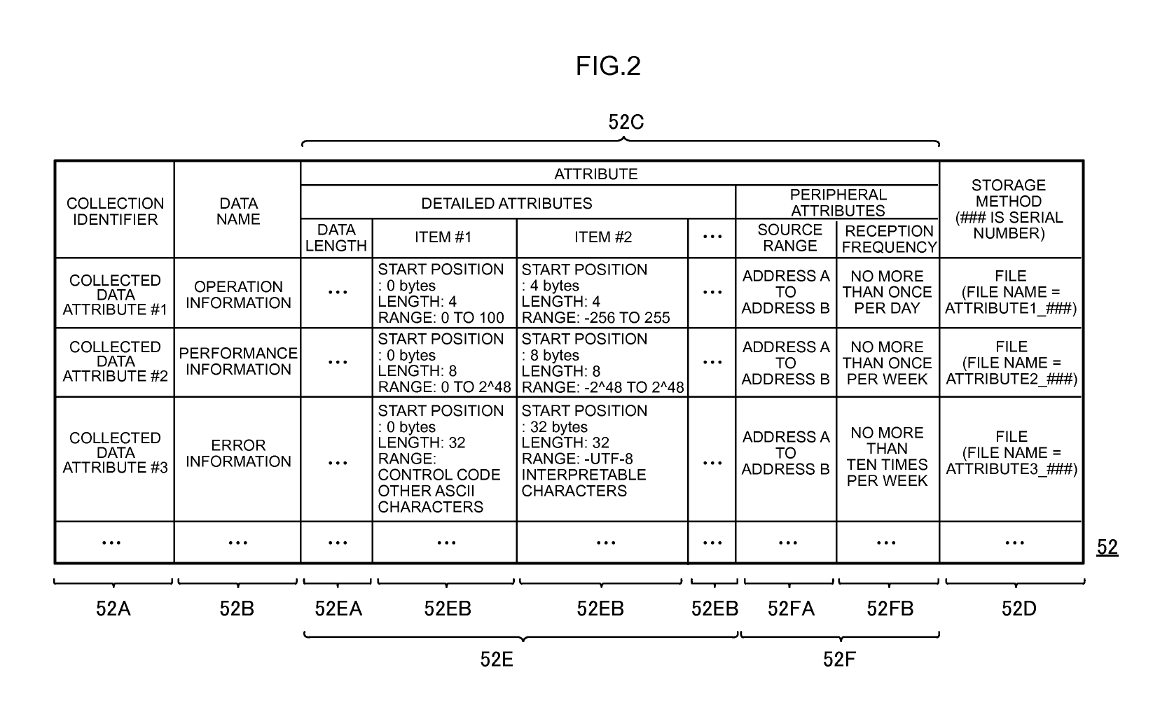

Further, the collected data attribute table 52 is a table which is used to manage the format and the like of each collected data attribute prescribed by the ‘prior arrangement’ with the data provider 10. As shown in FIG. 2, the collected data attribute table 52 is configured from a collection identifier field 52A, a data name field 52B, an attribute field 52C and a storage method field 52D.

Furthermore, the collection identifier field 52A stores collection identifiers which are assigned to the corresponding collected data attributes and the data name field 52B stores character strings (‘operation information,’ ‘performance information’ and ‘error information’ and so forth) representing labels which are assigned by the data exchange intermediary 20 to the corresponding collected data attributes to make it easy to discriminate the collected data attributes.

In addition, the attribute field 52C is configured from a detailed attributes field 52E for managing detailed attributes in the format and the like of the corresponding collected data attributes prescribed by the ‘prior arrangement’ with the data provider 10, and a peripheral attribute field 52F for managing peripheral attributes in the format of the collected data attributes.

Further, the detailed attributes field 52E is configured from a data length field 52EA and a plurality of item fields 52EB, wherein the data lengths of the collected data belonging to the corresponding collected data attributes prescribed by the ‘prior arrangement’ with the data provider are stored in the data length field 52EA and the formats of each of the information items contained in the collected data belonging to the corresponding collected data attributes prescribed by the ‘prior arrangement’ are stored in each of the corresponding item fields (item #1, item #2, . . . ) 52EB. For example, when measurement values such as engine speed, temperature and torque and the like are transmitted as a single collected data item, item #1 corresponds to the engine speed, item #2 corresponds to the temperature, item #3 corresponds to the torque . . . and information such as the data start position, length, and value range of these items which was prescribed by the ‘prior arrangement’ is stored in the respective item fields 52EB for each item.

Furthermore, the peripheral attribute field 52F is configured from a source range field 52FA and a reception frequency field 52FB, and the IP address range of the source of the collected data belonging to the corresponding collected data attribute prescribed by the ‘prior arrangement’ with the data provider 10 is stored in the source range field 52FA, while the reception frequency of the collected data belonging to the collected data attributes prescribed by the ‘prior arrangement’ is stored in the reception frequency field 52FB.

In addition, the storage method field 52D stores collected data storage methods for cases where the attributes of the received collected data correspond to the attributes prescribed by the ‘prior arrangement’ with the data provider 10 for the collected data attributes to which the collected data belongs.

Therefore, in the case of FIG. 2, it can be seen that, for the collected data of the collected data attribute called ‘operation information,’ for example, as prescribed by the ‘prior arrangement’ with the data provider 10, there should be a data length of ‘128’ bytes, an ‘item #1’ information item in which the ‘4′ bytes’ worth of data starting from the data header (‘0 byte’) takes a numerical value in the ‘0 to 100’ range and an ‘item #2’ information item in which the ‘4′ bytes’ worth of data starting from the ‘4 bytes’ position of the data takes a numerical value in the ‘−256 to 256’ range.

Furthermore, in the case of FIG. 2, it can be seen that, as prescribed by the ‘prior arrangement’ with the data provider 10, the range of source IP addresses of the data collection client 2 which transmits the collected data attribute (operation information) is ‘address A to address B’ and the frequency of transmission is ‘no more than once a day,’ and that, in a case where the collected data with this collected data attribute satisfies the format prescribed by the ‘prior arrangement’ for the collected data attribute, it is prescribed that the collected data be stored as a ‘file’ with a file name ‘attribute1_### (where ### is the serial number)’.

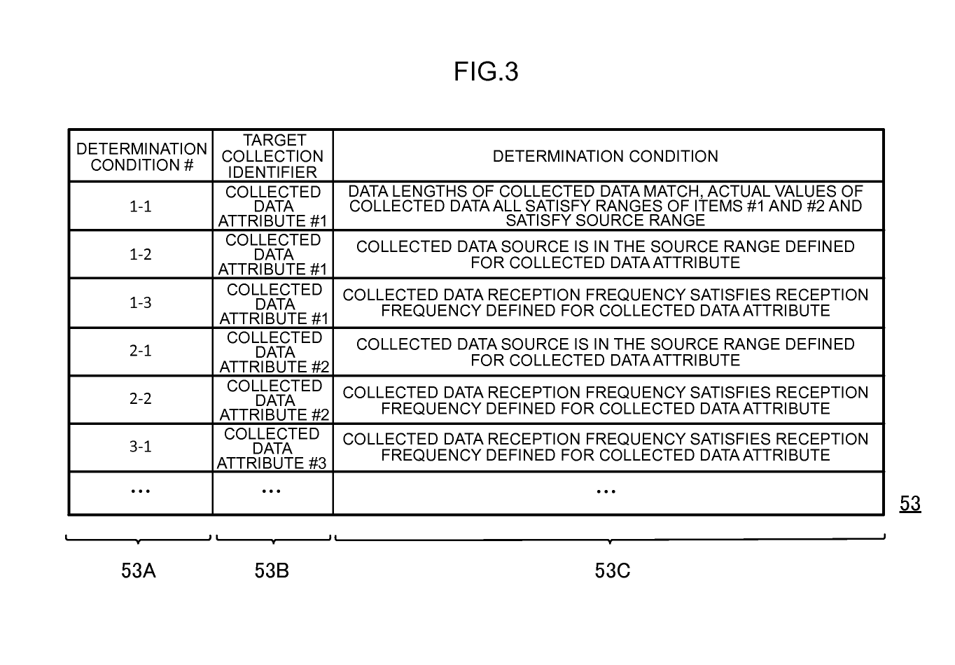

The variance determination condition definition table 53 is a table which is used by the mediation server 4 to manage the determination conditions for determining whether or not the format of the collected data and the like which was transmitted from the data collection client 2 corresponds to the format and the like prescribed by the ‘prior arrangement’ with the data provider 10 and, as shown in FIG. 3, is configured from a determination condition number field 53A, a target collection identifier field 53B and a determination condition field 53C.

Further, the determination condition number field 53A stores numbers which represent the priorities of each of the determination conditions (determination condition numbers). Note that, in FIG. 3, the numerical character on the left side of the determination condition number matches the collection identifier of the collected data attribute which is the target and the numerical character on the right side (the branch number) represents the priority of the determination condition of the corresponding collected data attribute. The smaller the numerical value on the right side, the higher this priority is. Accordingly, in the case of the example of FIG. 3, for example, the determination condition with the determination condition number ‘1-2’ has a higher priority than the determination condition with the determination condition number ‘1-3’ and the determination condition with the determination condition number ‘1-1’ has a higher priority than the determination condition with the determination condition number ‘1-2.’

Furthermore, the target collection identifier field 53B stores the collection identifier to which the corresponding determination condition is applied. Further, the determination condition field 53C stores determination conditions for when it is determined whether or not the collected data belonging to the corresponding collected data attribute is an attribute (format or the like) according to the ‘prior arrangement’ with the data provider.

Therefore, in the case of FIG. 3, it can be seen that three determination conditions ‘1-1’ to ‘1-3’ are specified for collected data which belongs to the collected data attribute (operation information) known as ‘collected data attribute #1,’ for example, and that the determination condition with the highest priority is ‘the data lengths of collected data match, and the actual values of the collected data all satisfy the ranges of items #1 and #2 and satisfy the source range, that the determination condition with the next highest priority is ‘collected data source is in the source range defined for the collected data attribute,’ and that the determination condition with the lowest priority is ‘collected data reception frequency satisfies the reception frequency defined for the collected data attribute.’

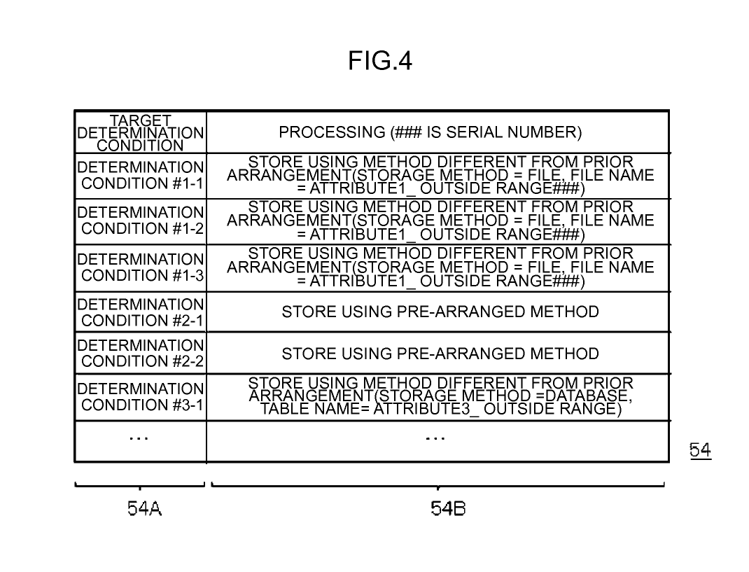

The collected data storage method definition table 54 is a table which is used to manage predefined processing methods (storage methods) for the collected data according to the determination result of the collected data processing method determination processing and, as shown in FIG. 4, is configured from a target determination condition field 54A and a processing field 54B.

Further, the target determination condition field 54A stores each of the determination condition numbers which are stored in the determination condition number field 53A of the variance determination condition definition table 53. In addition, the processing field 54B stores the collected data processing methods (storage methods) for cases where the determination condition of the corresponding determination condition number is not initially satisfied when the determination conditions are determined in order, starting with the determination condition with the highest priority. In such cases, the specific storage method and required parameters are stored in the processing field when the collected data is to be stored using a method which differs from the ‘prior arrangement.’

Therefore, in FIG. 4, it can be seen that, for the collected data of the collected data attribute (operation information in this example) which has the collection identifier ‘collected data attribute #1,’ for example, in a case where it is determined whether or not the determination conditions are satisfied, in order starting with the determination condition called ‘determination condition #1-1’ with the highest priority, and where the determination condition called ‘determination condition #1-3’ is not initially satisfied (a case where the determination conditions ‘determination condition #1-1’ and ‘determination condition #1-2’ are satisfied but the determination condition ‘determination condition #1-3 is not satisfied), the collected data is to be stored as a ‘file’ which is assigned the file name ‘attribute1_out of range###’ (where ### is the serial number). Further, in FIG. 4, it can be seen that the collected data of ‘collected data attribute #2’ is to be stored using a method according to the ‘prior arrangement’ in both cases, that is, in a case where it is determined whether or not the determination conditions are satisfied, in order starting with the ‘determination condition #2-1’ with the highest priority, and the determination condition ‘determination condition #2-1’ is not satisfied, and in a case where the determination condition ‘determination condition #2-1’ is satisfied but the determination condition ‘determination condition #2-2’ is not satisfied.

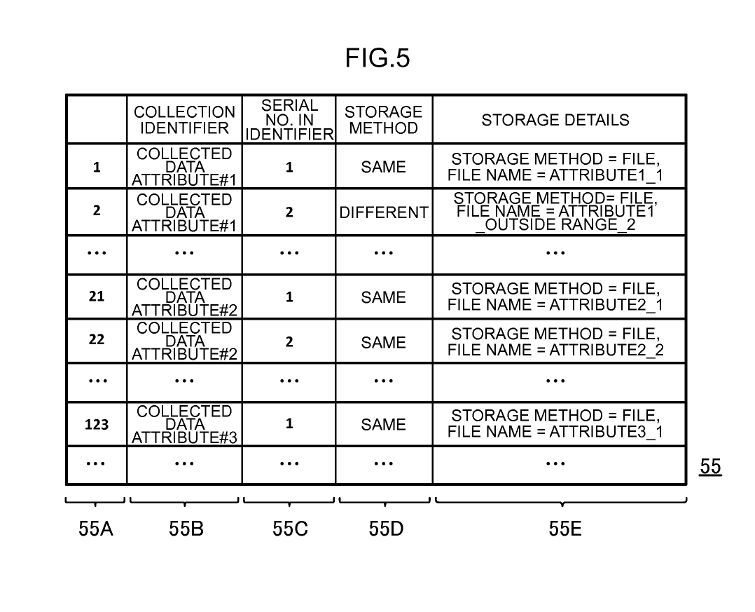

The collected data storage method recording table 55 is a table which is used to manage the storage methods of each of the collected data which is received and stored and, as shown in FIG. 5, is configured from a record number field 55A, a collection identifier field 55B, a serial number in identifier field 55C, a storage method field 55D and a storage details field 55E.

Furthermore, the record number field 55A stores identification numbers which are assigned to the records (rows) and the collection identifier field 55B stores collection identifiers of the collected data attributes to which the corresponding collected data belongs. Further, the serial number in identifier field 55C stores serial numbers in identifiers which are assigned to the corresponding collected data. The serial numbers in identifiers are serial numbers which are assigned to distinguish the collected data to which the same collection identifiers have been assigned (that is, collected data of the same collected data attributes), and different serial numbers in identifiers are sequentially assigned to the collected data of the same collected data attributes.

The storage method field 55D stores an indication of whether the corresponding collected data was stored using a storage method which was the same as or different from the storage method according to the ‘prior arrangement’ corresponding to the collected data attribute. More specifically, in cases where the corresponding collected data was stored using a storage method according to the ‘prior arrangement’ corresponding to the collected data attribute, a character string or code or the like indicating that the storage method was the ‘same’ is stored in the storage method field 55D, and in a case where the collected data was stored using a different storage method from the ‘prior arrangement’ corresponding to the collected data attribute, a character string or code or the like indicating that the method was ‘different’ is stored in the storage method field 55D.

In addition, the storage details field 55E stores the details of the storage method for the corresponding collected data. For example, in a case where the corresponding collected data is stored as a ‘file’ format, the storage details field 55E stores the information ‘storage method=file’ and the file name of this ‘file.’

Therefore, in the case of FIG. 5, it can be seen that the storage method for collected data to which ‘collected data attribute #1’ has been assigned as a collection identifier and ‘1’ has been assigned as a serial number in identifier, for example, is the ‘same’ as the storage method according to the ‘prior arrangement’ which was predetermined for the collected data attribute of this collected data and, more precisely, this collected data has been stored using in ‘file’ format and with the file name ‘attribute 1_{—}1.’

Note that, although a state where the collected data in the collected data storage method recording table 55 has been sorted so as to be arranged according to each collected data attribute in FIG. 5, the collected data may also be registered in the collected data storage method recording table 55 in the order in which this data was received and the storage methods for each of the collected data may be managed in an as-is state (that is, managed in a state where the storage methods have not been sorted so as to be arranged according to each collected data attribute).

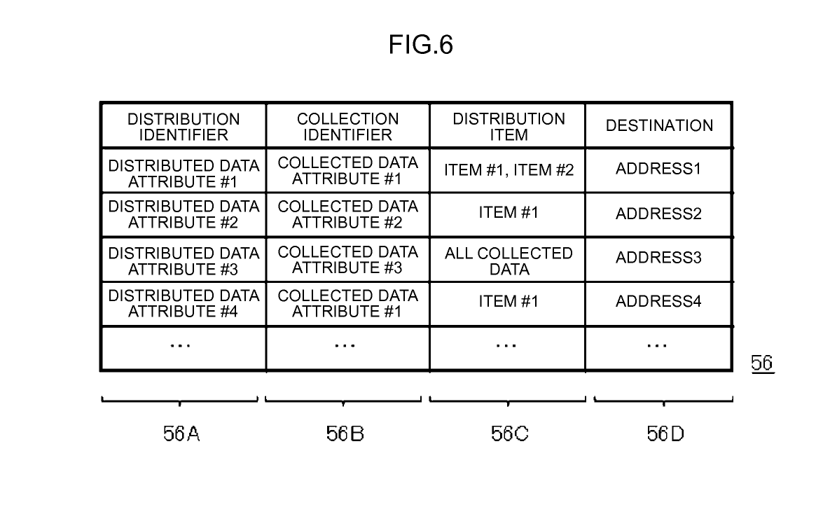

The distributed data attribute table 56 is a table which is used to manage the distributed data attributes and, as shown in FIG. 6, is configured from a distribution identifier field 56A, a collection identifier field 56B, a distribution item field 56C and a destination field 56D.

Further, the distribution identifier field 56A stores the distribution identifiers of each of the distributed data attributes of the distributed data which is transmitted from the mediation server 4 to the data destination client 6, and the collection identifier field stores the collection identifiers assigned to the distribution identifiers.

In addition, the distribution item field 56C stores information indicating the items to be distributed to the data destination client 6 (identification information identifying the items which are the distribution target) among the collected data belonging to the corresponding collected data attributes. In a case where the distribution target is all the collected data, a character string or code or the like indicating this fact Call collected data′) is stored in the distribution item field 56C. Further, the destination field 56D stores the addresses of the data destination clients 6 which are the destinations of the corresponding distributed data.

Therefore, in the case of FIG. 6, it can be seen that the distribution identifier called ‘distributed data attribute #1’ is assigned to the collection identifier called ‘collected data attribute #1’ and that the data of ‘items #1, #2’ among the collected data belonging to this collection identifier is to be transmitted to the data destination client 6 at ‘address 1.’

### (1-3) Various Processing Related to the Data Collection and Distribution Function According to this Embodiment

The processing content of various processing which is executed in connection with the data collection and distribution function according to this embodiment will be described next. Note that although the subject of the various processing is described hereinbelow as a ‘program ( . . . unit),’ it goes without saying that, in reality, the CPU 21 (FIG. 1) of the mediation server 4 executes this processing based on these programs.

### (1-3-1) Data Collection Processing

### (1-3-1-1) Data Collection Processing

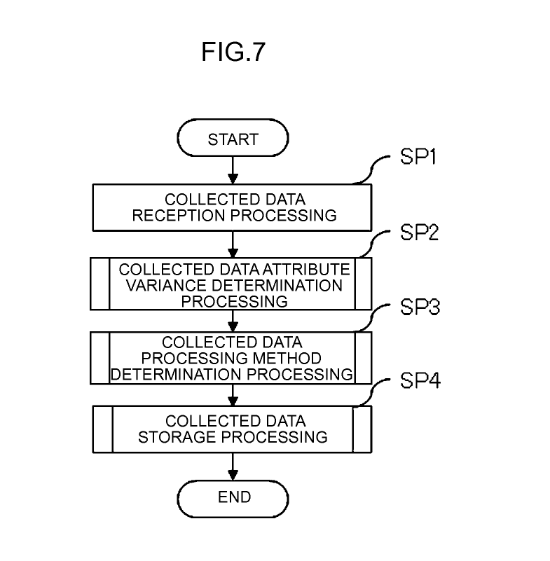

FIG. 7 shows a processing routine for the data collection processing which is executed in the mediation server 4 when the collected data is transmitted from the data collection client 2.

The data collection processing is started in the mediation server 4 when collected data is being transmitted from the data collection client 2, and first reception processing to receive this collected data is executed by the collected data reception unit 40 (FIG. 1) (SP1). Note that this collected data also includes the collected data attributes as described hereinabove.

Thereafter, the collected data attribute variance determination processing, which determines whether or not the collected data attributes (format and the like) are at variance with the format and the like according to the ‘prior arrangement’ which was prescribed for the collected data attributes to which the collected data belong, is executed by the collected data attribute variance determination unit 41 (FIG. 1) (SP2).

Subsequently, the collected data processing method determination processing, which determines the processing methods (storage methods) for the collected data based on the processing result of the collected data attribute variance determination processing, is executed by the collected data processing method determination unit 42 (FIG. 1) (SP3).

In addition, the collected data storage processing, which stores the collected data according to the processing result of the collected data processing method determination processing, is executed by the collected data storage processing unit 43 (FIG. 1) (SP4), and thereafter the data collection processing ends.

### (1-3-1-2) Collected Data Attribute Variance Determination Processing

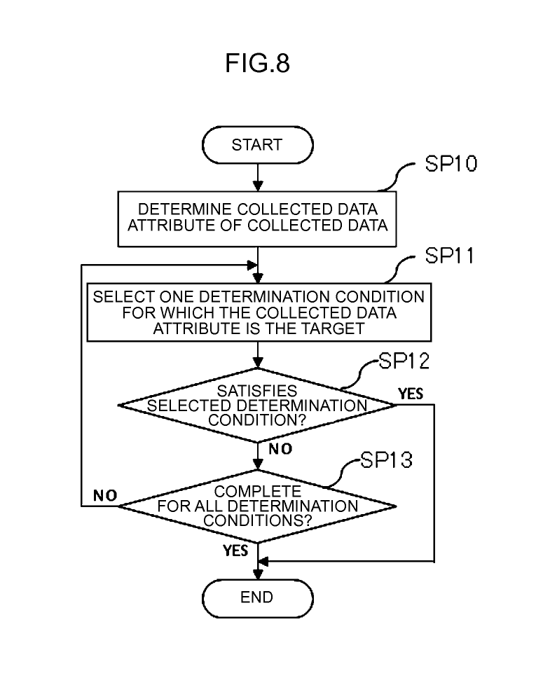

FIG. 8 shows specific processing content for the collected data attribute variance determination processing which is executed by the collected data attribute variance determination unit 41 in step SP2 of the data collection processing which was described hereinabove with reference to FIG. 7.

Upon starting this collected data attribute variance determination processing, the collected data attribute variance determination unit 41 first specifies the collected data attribute of the collected data from the collection identifier contained in the collected data then serving as the target (SP10).

Subsequently, the collected data attribute variance determination unit 41 selects, from the variance determination condition definition table 53 (FIG. 3), one determination condition with the highest priority which is an unprocessed determination condition from among the determination conditions and for which the collection identifier stored in the target collection identifier field 53B matches the collection identifier of the collected data attribute specified in step SP10 (SP11).

Thereafter, the collected data attribute variance determination unit 41 determines whether or not the format and the like of the collected data satisfies the determination condition selected in step SP11 according to the determination condition selected in step SP11 (SP12). Further, if an affirmative result is obtained in this determination, the collected data attribute variance determination unit 41 ends the collected data attribute variance determination processing.

If, on the other hand, a negative result is obtained in the determination of step SP12, the collected data attribute variance determination unit 41 determines whether or not execution of the processing of step SP12 is complete for all the determination conditions which are registered in the variance determination condition definition table 53 and for which the collection identifier stored in the target collection identifier field 53B matches the collection identifier of the collected data attribute specified in step SP10 (SP13).

If a negative result is obtained in this determination, the collected data attribute variance determination unit 41 returns to step SP11 and subsequently repeats the processing of steps SP11 to SP13 while sequentially switching the determination condition selected in step SP11 to an unprocessed determination condition.

Further, if an affirmative result is obtained in step SP13 as a result of already completing execution of the processing of step SP12 for all the determination conditions which are registered in the variance determination condition definition table 53 and for which the collection identifier stored in the target collection identifier field 53B matches the collection identifier of the collected data attribute specified in step SP10, the collected data attribute variance determination unit 41 ends this collected data attribute variance determination processing.

(1-3-1-3) Collected Data Processing Method Determination Processing

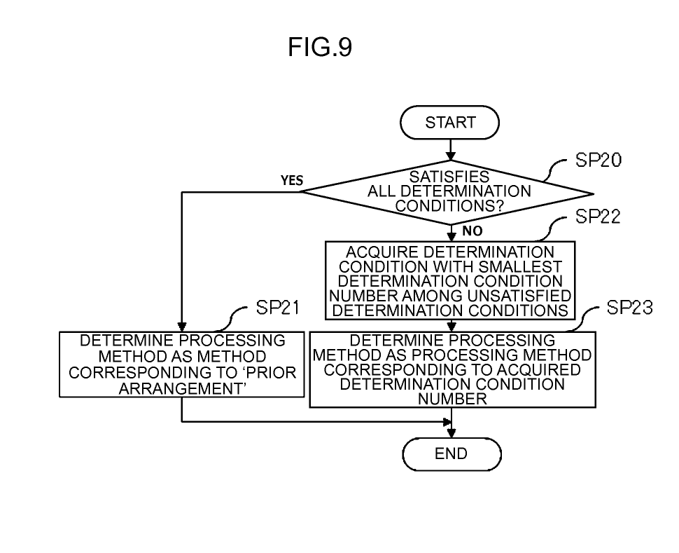

FIG. 9 shows specific processing content for the collected data processing method determination processing which is executed by the collected data processing method determination unit 42 in step SP3 of the data collection processing which was described hereinabove with reference to FIG. 7.

Upon starting this collected data processing method determination processing, the collected data processing method determination unit 42 first determines whether or not the collected data then serving as the target satisfies all the determination conditions specified for the collected data attribute of the collected data, based on the processing result of step SP12 of the foregoing collected data attribute variance determination processing (FIG. 8) (SP20).

Obtaining an affirmative result in this determination signifies that the format of the collected data is the format or the like according to the ‘prior arrangement’ for the collected data attribute to which the collected data belongs. Thus, the collected data processing method determination unit 42 then determines the processing method (storage method) for the collected data to be the method according to the ‘prior arrangement’ for the collected data attribute to which the collected data belongs (SP21) and subsequently ends the collected data processing method determination processing.

If, on the other hand, a negative result is obtained in the determination of step SP20, this means that the format of the collected data is not the format according to the ‘prior arrangement’ for the collected data attribute to which the collected data belongs. The collected data processing method determination unit 42 then accordingly acquires the determination condition number of the determination condition with the smallest determination condition number (the highest priority) among the determination conditions not satisfied by the collected data (SP22).

The collected data processing method determination unit 42 subsequently determines the processing method (storage method) which was specified in the collected data storage method definition table 54 for the determination condition number acquired in step SP22 as the collected data processing method (SP23) and subsequently ends the collected data processing method determination processing.

### (1-3-1-4) Collected Data Storage Processing

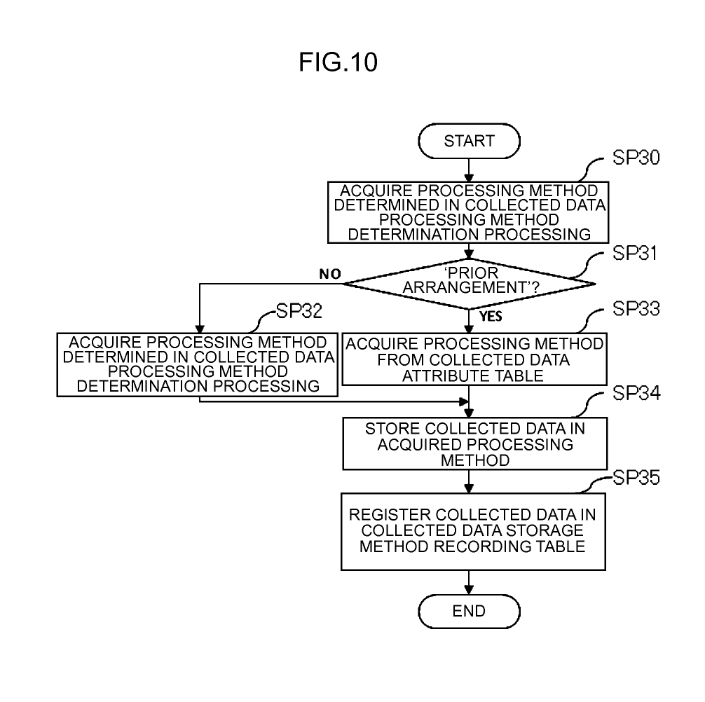

FIG. 10 shows specific processing content for the collected data storage processing which is executed by the collected data storage processing unit 43 in step SP4 of the data collection processing described hereinabove with reference to FIG. 7.

Upon starting the collected data storage processing, the collected data storage processing unit 43 first acquires, from the collected data processing method determination unit 42, the processing method (storage method) for the collected data then serving as the target which was determined in the foregoing collected data processing method determination processing (FIG. 9) (SP30).

The collected data storage processing unit 43 subsequently determines whether or not the processing method acquired in step SP30 is a storage method according to the ‘prior arrangement’ (SP31).

If a negative determination is obtained in the determination of step SP31, the collected data storage processing unit 43 acquires, from the collected data storage method definition table 54 (FIG. 4), the processing method (storage method) determined in step SP23 of the foregoing collected data processing method determination processing (FIG. 9) (SP32). Further, if an affirmative result is obtained in the determination of step SP31, the collected data storage processing unit 43 acquires the processing method according to the ‘prior arrangement’ for the collected data from the collected data attribute table 52 (FIG. 2) (SP33).

The collected data storage processing unit 43 subsequently stores the collected data then serving as the target by means of the processing method acquired in step SP32 or step SP33 (SP34). Thereupon, the collected data storage processing unit 43 stores the collected data in the collected data storage unit 50 (FIG. 1) in the secondary memory device 23 in cases where this collected data is stored by means of the processing method according to the ‘prior arrangement.’ If, on the other hand, this collected data was stored by means of a processing method other than the ‘prior arrangement,’ the collected data storage processing unit 43 stores the collected data in the collected data alternative storage unit 51 (FIG. 1) of the secondary memory device 23.

Further, the collected data storage processing unit 43 registers the collected data in the collected data storage method recording table 55 (FIG. 5) (SP35) and subsequently ends the collected data storage processing.

### (1-3-2) Data Distribution Processing

### (1-3-2-1) Data Distribution Processing

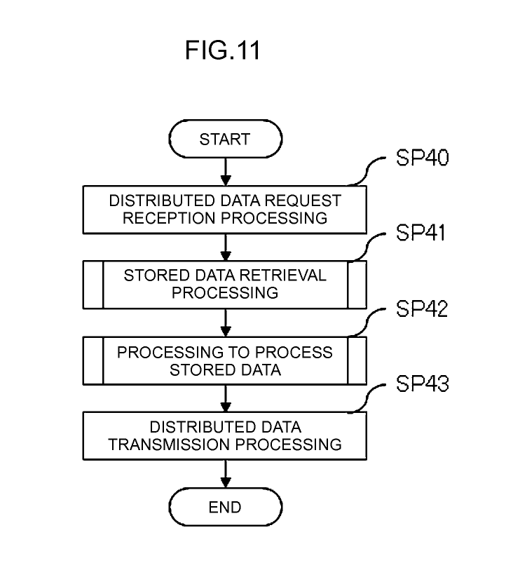

FIG. 11 shows a processing routine for data distribution processing which is executed in the mediation server 4 when a data distribution request has been transmitted from the data destination client 6.

The data distribution processing is started in the mediation server 4 when a data distribution request is being transmitted from the data destination client 6, and first reception processing to receive this data distribution request is executed by the data distribution request reception unit 44 (FIG. 1) (SP40). Note that here the data distribution request also contains a distribution identifier which represents the distributed data attribute of the distributed data being requested as described hereinabove.

Thereafter, stored data retrieval processing for retrieving the collected data requested by the data distribution request from the collected data storage unit 50 (FIG. 1) in the secondary memory device 23 is executed by the stored data retrieval unit 45 (FIG. 1) (SP41).

Subsequently, processing to process the stored data, which processes the format of the collected data retrieved from the collected data storage unit 50 in the secondary memory device 23 by the stored data retrieval unit 45 so that this collected data is in the format according to the ‘prior arrangement’ with the data user, is executed by the stored data processing unit 46 (FIG. 1) (SP42).

In addition, distributed data transmission processing, which transmits the collected data, processed by the processing for processing the stored data, as distributed data to the data destination client 6 which was the source of the data distribution request, is executed by the distributed data transmission unit 47 (FIG. 1) (SP43) and subsequently ends the data distribution processing.

### (1-3-2-2) Stored Data Retrieval Processing

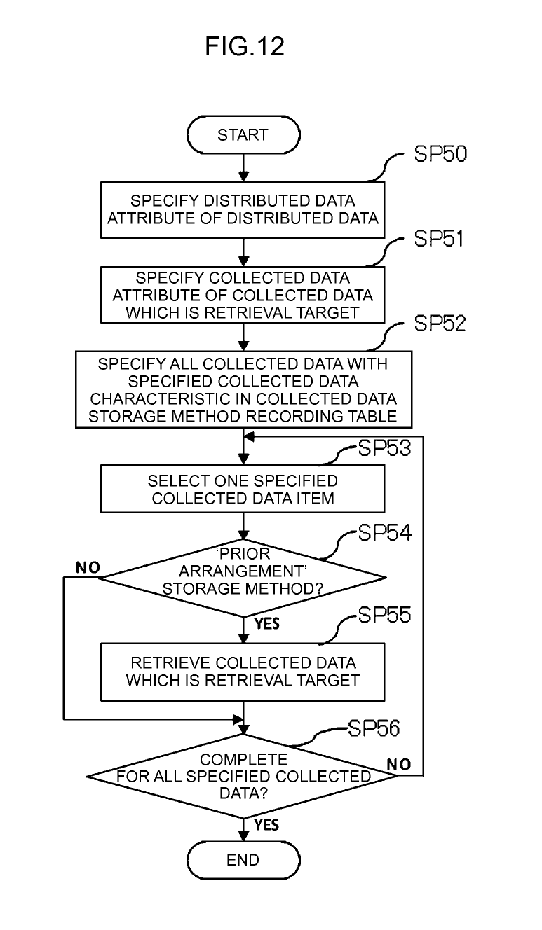

FIG. 12 shows specific processing content for stored data retrieval processing which is executed by the stored data retrieval unit 45 in step SP41 of the data distribution processing described hereinabove with reference to FIG. 11.

Upon starting this stored data retrieval processing, the stored data retrieval unit 45 first refers to the distributed data attribute table 56 (FIG. 6) based on the distribution identifier contained in the data distribution request and specifies the distributed data attribute of the distributed data (SP50).

The stored data retrieval unit 45 subsequently refers to the distributed data attribute table 56 and specifies the collected data attribute corresponding to the distributed data attribute specified in step SP50 (the collected data attribute of the collected data to be retrieved from the collected data storage unit 50 in the secondary memory device 23) (SP51).

Furthermore, the stored data retrieval unit 45 specifies all the collected data having the collected data attribute which was specified in step SP51 in the collected data storage method recording table 55 (FIG. 5) (SP52).

The stored data retrieval unit 45 then selects one collected data item from among the collected data specified in step SP52 (SP53) and refers to the collected data storage method recording table 55 to determine whether or not the selected collected data storage method is the storage method according to the ‘prior arrangement’ determined for the collected data attribute of the collected data (SP54).

Here, obtaining a negative result in the determination of step SP54 signifies that the format or the like of the collected data then serving as the target is not the format or the like according to the ‘prior arrangement’ which was predetermined for the collected data attribute of the collected data. The stored data retrieval unit 45 then accordingly advances to step SP56.

On the other hand, obtaining an affirmative result in the determination of step SP54 signifies that the format or the like of the collected data then serving as a target is the format or the like according to the ‘prior arrangement’ predetermined for the collected data attribute of this collected data. The stored data retrieval unit 45 accordingly then retrieves the collected data then serving as the target from the collected data storage unit 50 in the secondary memory device 23 (SP55).

The stored data retrieval unit 45 subsequently determines whether or not execution of the processing of steps SP54 and SP55 is complete for all the collected data which was specified in the collected data storage method recording table 55 in step SP52 (SP56).

If a negative result is obtained in this determination, the stored data retrieval unit 45 returns to step SP54 and subsequently repeats the processing of steps SP53 to SP56 while sequentially switching the collected data selected in step SP53 to other unprocessed collected data.

Further, if an affirmative result is obtained in step SP56 as a result of already completing the execution of the processing of steps SP54 and SP55 for all the collected data which was specified in the collected data storage method recording table 55 in step SP52, the stored data retrieval unit 45 ends the stored data retrieval processing.

### (1-3-2-3) Processing to Process Stored Data

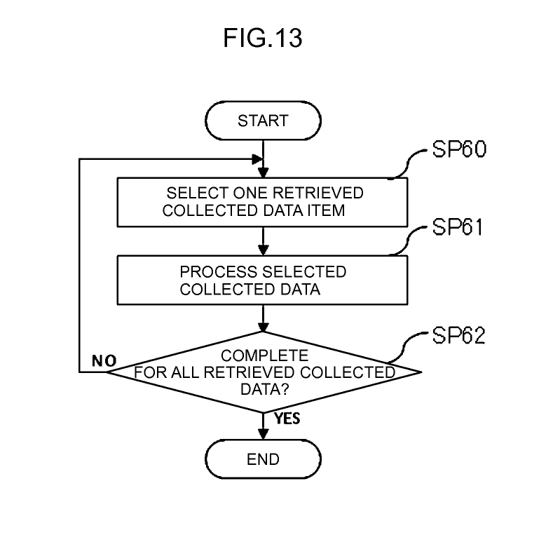

FIG. 13 shows specific processing content for the processing to process stored data which is executed by the stored data processing unit 46 in step SP42 of the data distribution processing described hereinabove with reference to FIG. 11.

Upon starting the processing to process the stored data, the stored data processing unit 46 first selects one collected data item which was retrieved from the collected data storage unit 50 in the secondary memory device 23 in the foregoing processing to process the stored data (FIG. 12) (SP60), refers to the distributed data attribute table 56 (FIG. 6), and executes the processing to process the format of the selected collected data to convert same to the format according to the ‘prior arrangement’ with the data user (SP61).

The stored data processing unit 46 subsequently determines whether or not the execution of the processing of step SP61 is complete for all the collected data which was retrieved from the collected data storage unit 50 in the secondary memory device 23 in the stored data retrieval processing (SP62).

Further, if a negative result is obtained in this determination, the stored data processing unit 46 returns to step SP60 and subsequently repeats the processing of steps SP60 to SP62 while sequentially switching the collected data selected in step SP60 to other unprocessed collected data.

Furthermore, if an affirmative result is obtained in step SP62 as a result of already completing the execution of the processing of step SP61 for all the collected data retrieved from the collected data storage unit 50 in the secondary memory device 23 in the stored data retrieval processing, the stored data processing unit 46 ends the processing to process the stored data.

Note that, as described hereinabove for step SP43 in FIG. 11, the collected data which has been processed in this way by the stored data processing unit 46 is subsequently transmitted to the data destination client 6 which was the source of the data distribution request by the distributed data transmission unit 47 (FIG. 1).

### (1-4) Advantageous Effects of Embodiment

As described hereinabove, in the data collection and distribution system 1 according to this embodiment, the mediation server 4 selectively transmits only the collected data in the format or the like according to the ‘prior arrangement’ between the data provider 10 and the data exchange intermediary 20, among the collected data which was transmitted from the data collection client 2, to the data destination client 6 in response to the data distribution request from the data destination client 6.

Therefore, in this data collection and distribution system 1, only the collected data according to the ‘prior arrangement’ between the data exchange intermediary 20 and the data user 30 is always transmitted as distributed data from the mediation server 4 to the data destination client 6, even in cases where the collected data which is transmitted from the data collection client 4 to the mediation server 4 is a mixture of collected data which is in the format according to the ‘prior arrangement’ between the data provider 10 and the data exchange intermediary 20 and in a format or the like which differs from the ‘prior arrangement.’

Accordingly, with the data collection and distribution system 1, it is possible to effectively prevent distributed data, which is in a format which differs from the ‘prior arrangement’ due to an update to the data collection client 2 or a data collection test by the data provider 10, from being distributed from the mediation server 4 to the data destination client 6, and therefore the data provider 10 is able to freely conduct updates to the data collection client 2 and data collection tests at the convenience of the data provider 10. The convenience of the data provider can accordingly be improved.

### (2) Second Embodiment

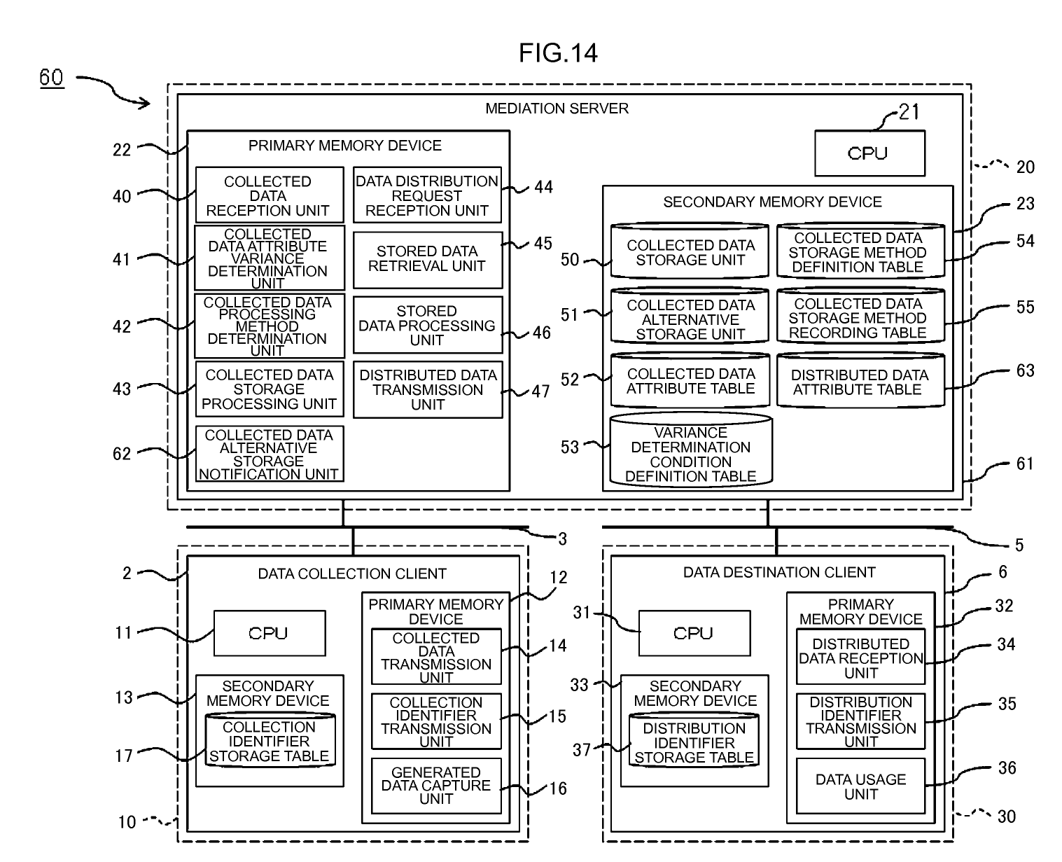

FIG. 14, which is shown having the same reference signs assigned to corresponding parts as FIG. 1, shows a data collection and distribution system 60 according to a second embodiment. This data collection and distribution system 60 is configured in the same way as the data collection and distribution system 1 according to the first embodiment except for having an installation of a collected data alternative storage notification function which, in cases where the collected data format or the like is a format or the like which differs from the ‘prior arrangement,’ notifies the data destination client 6, which was originally supposed to receive distribution of the collected data, of the fact that the collected data was stored using a method which differs from the ‘prior arrangement’ (stored in the collected data alternative storage unit 51 in the secondary memory device 23).

In reality, in the data collection and distribution system 1 according to this embodiment, a collected data alternative storage notification unit 62 is stored in the primary memory device 22 of a mediation server 61 in addition to the various programs described hereinabove with reference to the first embodiment. This collected data alternative storage notification unit 62 is a program comprising a function which, in a case where the collected data storage processing unit 43 (FIG. 1) has stored the collected data using a storage method which differs from the ‘prior arrangement,’ notifies the data destination client 6, which was originally supposed to receive distribution of this collected data, of this fact. Note that hereinbelow this notification is called the ‘collected data alternative storage notification.’

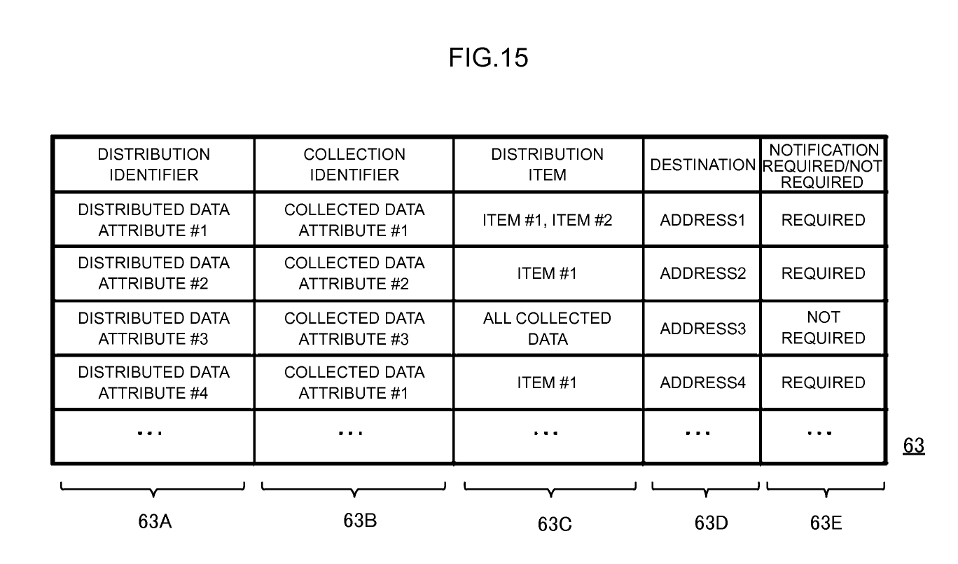

Furthermore, in the case of this embodiment, as shown in FIG. 15, the distributed data attribute table 63 comprises a notification required/not required field 63E in addition to a distribution identifier field 63A, a collection identifier field 63B, a distribution item field 63C and a destination field 63D which each store information which is the same as that of the distribution identifier field 56A, collection identifier field 56B, distribution item field 56C and destination field 56D respectively of the distributed data attribute table 56 (FIG. 6) according to the first embodiment.

Further, the notification required/not required field 63E stores information (character strings or codes or the like) indicating whether or not there is a requirement to transmit the foregoing collected data alternative storage notification according to the ‘prior arrangement’ with the data user 30 (FIG. 1) which receives distribution of the distributed data having the corresponding distributed data attribute. More specifically, the notification required/not required field 63E stores ‘required’ in cases where there is a requirement to transmit the collected data alternative storage notification to the corresponding data destination client 6, and stores ‘not required’ in cases where no such notification is required.

In a case where collected data has been stored in the collected data alternative storage unit 51 in the secondary memory device 23 by the collected data storage processing unit 43 and where ‘not required’ is stored in the corresponding notification required/not required field 63E in the distributed data attribute table 63, the collected data alternative storage notification unit 62 does not transmit a collected data alternative storage notification to the data destination client 6 which was supposed to receive distribution of the collected data of the distributed data attribute; however, in a case where ‘required’ is stored in the corresponding notification required/not required field 63E in the distributed data attribute table 63, the collected data alternative storage notification unit 62 transmits a collected data alternative storage notification to the data destination client 6 which was supposed to receive distribution of the collected data of the distributed data attribute.

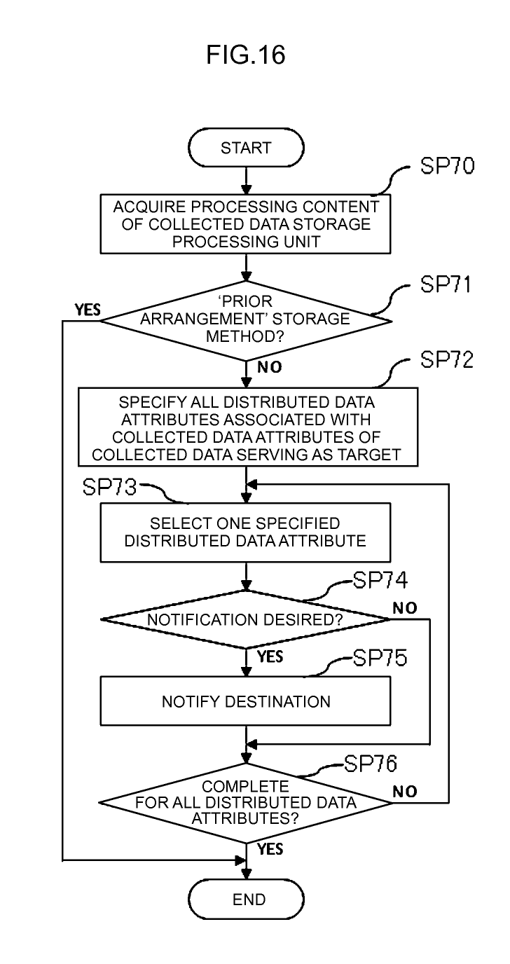

FIG. 16 shows a specific processing routine for the collected data alternative storage notification processing which is executed by this collected data alternative storage notification unit 62. When the collected data storage processing (FIG. 10) by the collected data storage processing unit 43 is complete, the collected data alternative storage notification unit 62 starts the collected data alternative storage notification processing shown in FIG. 16 and first issues an inquiry to the collected data storage processing unit 43 regarding the processing content of the collected data storage processing which is then being executed (SP70).

The collected data alternative storage notification unit 62 subsequently determines whether or not the collected data then serving as the target was stored in the collected data storage unit by means of the storage method according to the ‘prior arrangement,’ based on the result of the inquiry in step SP70 (SP71). Further, if an affirmative result is obtained in this determination, the collected data alternative storage notification unit 62 ends the collected data alternative storage notification processing.

If, on the other hand, a negative result is obtained in the determination of step SP71, the collected data alternative storage notification unit 62 refers to the distributed data attribute table 63 and specifies all the distributed data attributes which are associated with the collected data attributes to which the collected data then serving as the target belongs (SP72).

Subsequently, the collected data alternative storage notification unit 62 selects one distributed data attribute from among the distributed data attributes specified in step SP72 (SP73), refers to the distributed data attribute table 63, and determines whether or not there is a requirement to transmit a collected data alternative storage notification to the corresponding data destination client 6 for the distributed data attribute selected in step SP73 (SP74).

Furthermore, if a negative result is obtained in this determination, the collected data alternative storage notification unit 62 advances to step SP76. If, on the other hand, an affirmative result is obtained in the determination of step SP74, the collected data alternative storage notification unit 62 refers to the distributed data attribute table 63 and transmits a collected data alternative storage notification to the data destination client 6 which was supposed to receive distribution of the collected data (SP74).

Thereafter, the collected data alternative storage notification unit 62 determines whether or not the processing of steps SP74 and SP75 is complete for all the distributed data attributes specified in step SP72 (76). Further, if a negative result is obtained in this determination, the collected data alternative storage notification unit 62 returns to step SP73 and subsequently repeats the processing of steps SP73 to SP76 while sequentially switching the distributed data attribute selected in step SP73 to another unprocessed distributed data attribute.

Further, if an affirmative result is obtained in step SP76 as a result of already completing the processing of steps SP74 and SP75 for all the distributed data attributes specified in step SP72, the collected data alternative storage notification unit 62 ends the collected data alternative storage notification processing.

As described hereinabove, in the data collection and distribution system 60 according to this embodiment, collected data in a format or the like which differs from the ‘prior arrangement’ between the data provider 10 and the data exchange intermediary 20 is supplied from the data collection client 2 to the mediation server 61, and if the collected data was stored in the collected data alternative storage unit 51, the mediation server 61 notifies the data destination client 6 of this fact, therefore enabling the data user to recognize the existence of this collected data.

Accordingly, in a case where the data user would like to use such collected data, for example, the data user is also able to use such collected data by issuing a request, from the data destination client 6 to the mediation server 61, to distribute this collected data.

Accordingly, with this data collection and distribution system 60, it is possible to shorten the time until the data user 30 is able to use collected data whose format has been changed due to collected data format changes at the convenience of the data provider 10, and therefore, in addition to the effects obtained by the first embodiment, this data collection and distribution system 60 also affords the effect of enabling the convenience of the data user to be improved.

### (3) Third Embodiment

### (3-1) Configuration of Data Collection and Distribution System According to this Embodiment

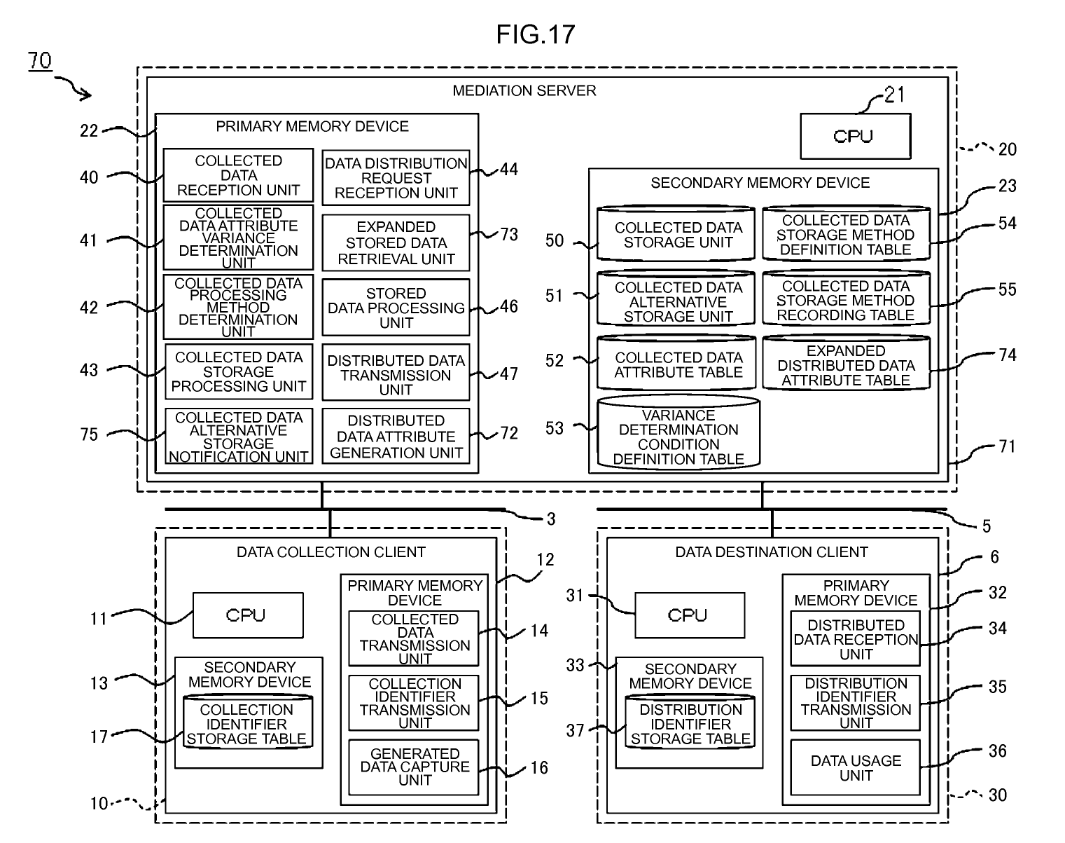

FIG. 17, which is shown having the same reference signs assigned to corresponding parts as FIG. 14, shows a data collection and distribution system 70 according to a third embodiment. This data collection and distribution system 70 is configured in the same way as the data collection and distribution system 60 according to the second embodiment except that a first expanded data distribution function is installed on a mediation server 71.

Here, the first expanded data distribution function is a function which manages the collected data which was stored using a storage method which differs from the ‘prior arrangement’ (that is, stored in the collected data alternative storage unit 51) by associating this collected data with new distributed data attributes, notifies the data destination client 6 of the existence of the new distributed data attributes, and provides the collected data belonging to the new distributed data attributes to the data destination client 6 according to a data distribution request from the data destination client 6.

As means for realizing this first expanded data distribution function, the primary memory device 22 of the mediation server 71 stores a distributed data attribute generation unit 72 in addition to the collected data reception unit 40, the collected data attribute variance determination unit 41, the collected data processing method determination unit 42, the collected data storage processing unit 43, the data distribution request reception unit 44, the stored data processing unit 46 and the distributed data transmission unit 47. Furthermore, the primary memory device 22 of the mediation server 71 stores an expanded stored data retrieval unit 73 instead of the stored data retrieval unit 45 (FIG. 14) and the secondary memory device 23 of the mediation server 71 stores an expanded distributed data attribute table 74 instead of the distributed data attribute table 63 (FIG. 14).

The distributed data attribute generation unit 72 is a program comprising a function which generates a new distributed data attribute which is associated with the collected data in a case where the collected data was stored in the collected data alternative storage unit 51 in the secondary memory device 23 by the collected data storage processing unit 43 (that is, a case where the collected data format did not satisfy the format or the like of the ‘prior arrangement’), and registers the generated new distributed data attribute in the expanded distributed data attribute table 74.

Furthermore, the expanded stored data retrieval unit 73 is a program comprising a function which retrieves (reads) the collected data of the distributed data attributes whose distribution was requested from the data destination client 6 (including new distributed data attributes generated by the distributed data attribute generation unit 72) from the collected data storage unit 50 or collected data alternative storage unit 51.

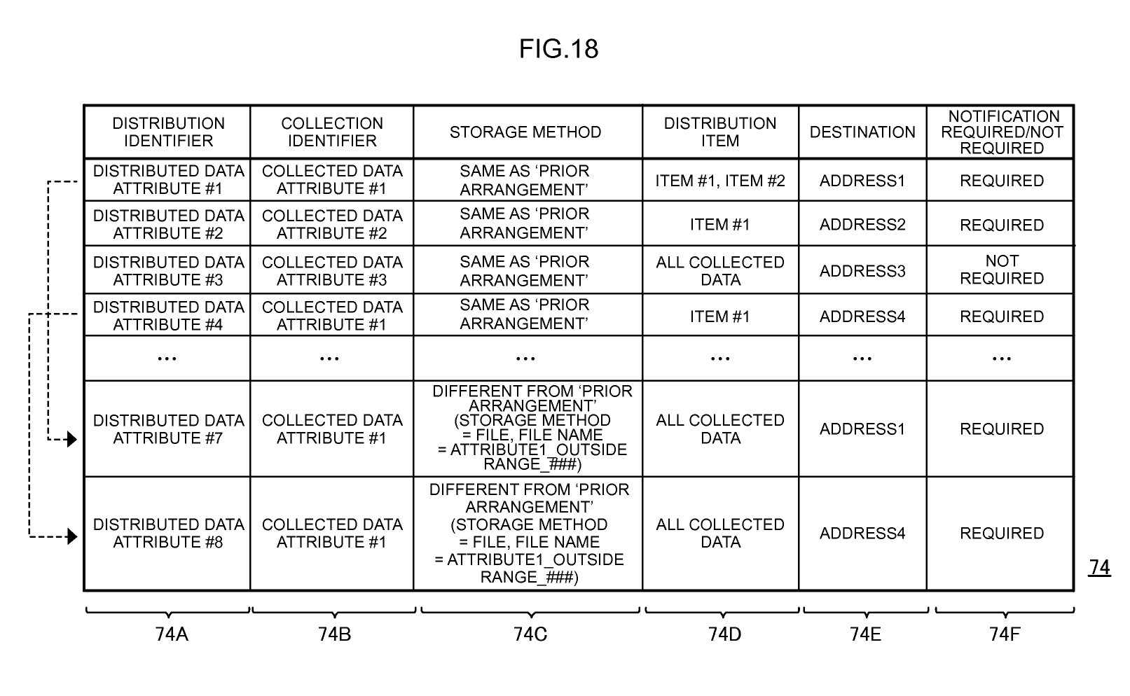

In addition, the expanded distributed data attribute table 74 is a table which is used to manage distributed data attributes and, as shown in FIG. 18, is configured from a distribution identifier field 74A, a collection identifier field 74B, a storage method field 74C, a distribution item field 74D, a destination field 74E and a notification required/not required field 74F.

Further, the distribution identifier field 74A, collection identifier field 74B, distribution item field 74D, destination field 74E and notification required/not required field 74F store the same information as the information which is stored in the distribution identifier field 63A, collection identifier field 63B, distribution item field 63C, destination field 63D and notification required/not required field 63E in the distributed data attribute table 63 according to the second embodiment described hereinabove with reference to FIG. 15.

Furthermore, the storage method field 74C stores the storage method for the corresponding collected data. In this case, the storage method field 74C of a record (row) which corresponds to an existing distributed data attribute prescribed by the ‘prior arrangement’ stores information to the effect that the corresponding collected data was stored by means of the storage method prescribed by the ‘prior arrangement’ (a character string or code or the like expressing ‘same as the prior arrangement’). However, the storage method field 74C of a record which corresponds to a newly generated distributed data attribute stores information to the effect that the corresponding collected data was stored by means of a method which differs from the ‘prior arrangement’ (a character string or code or the like expressing ‘different from the prior arrangement’), and information representing the specific storage method for the collected data (storage technique, file name and the like).

Therefore, in the case of FIG. 18, it can be seen that, for the final record (row), the collected data which belongs to ‘collected data attribute #1’ which was transmitted from the data collection client in a format or the like which differs from the ‘prior arrangement’ was stored as a ‘file’ which was assigned a file name ‘attribute1_out of range_###,’ and this collected data is associated with a distribution identifier called ‘distributed data attribute #8.’

### (3-2) Various Processing which is Executed in Connection with the First Expanded Data Distribution Function

### (3-2-1) Distributed Data Attribute Generation Processing

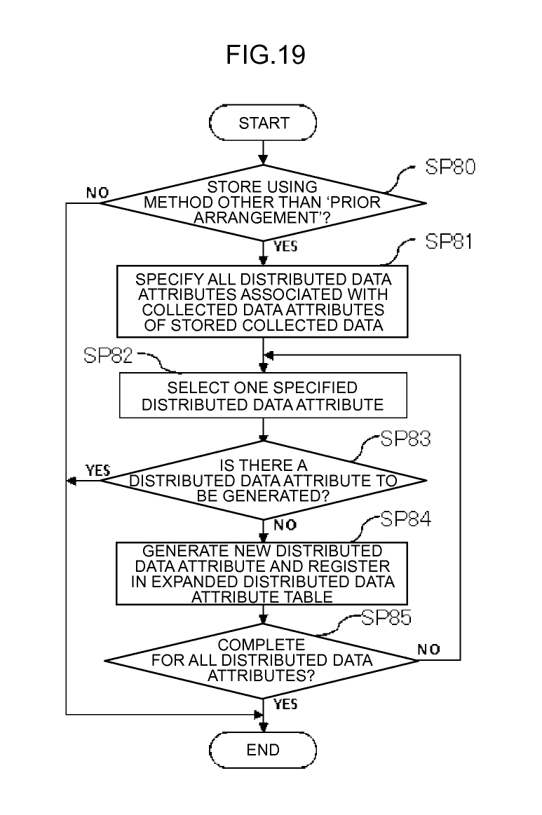

FIG. 19 shows a processing routine for distributed data attribute generation processing which is executed by the distributed data attribute generation unit 72. The distributed data attribute generation unit 72 executes the distributed data attribute generation processing shown in FIG. 19 after the collected data storage processing described hereinabove with reference to FIG. 10 has been executed by the collected data storage processing unit 43 and before the collected data alternative storage notification processing described hereinabove with reference to FIG. 16 is executed by the collected data alternative storage notification unit 75.

Upon starting the distributed data attribute generation processing, the distributed data attribute generation unit 72 first issues an inquiry to the collected data storage processing unit 43 regarding whether or not the collected data was stored using a storage method other than the ‘prior arrangement’ in the collected data storage processing which was executed beforehand by the collected data storage processing unit 43 (SP80). Further, when this collected data was stored using a storage method according to the ‘prior arrangement’ (SP80: NO), the distributed data attribute generation unit 72 ends the distributed data attribute generation processing.

If, on the other hand, this collected data was stored using a storage method other than the ‘prior arrangement’ (SP80: YES), the distributed data attribute generation unit 72 specifies all the distributed data attributes associated with the collected data attributes of this collected data, in the expanded distributed data attribute table 74 (SP81).

The distributed data attribute generation unit 72 subsequently selects one distributed data attribute from among the distributed data attributes specified in step SP81 (SP82) and refers to the expanded distributed data attribute table 74 to determine whether or not the distributed data attribute which is to be generated in connection with the selected distributed data attribute exists (SP83). More specifically, in step SP83, the distributed data attribute generation unit 72 refers to the expanded distributed data attribute table 74 to determine whether or not a distributed data attribute exists for a case where the storage method for the collected data, which is associated with the same collection identifier as the collection identifier with which the distributed data attribute selected in step SP82 is associated and which belongs to the collected data attribute to which this collection identifier was assigned, was a storage method using a method other than the ‘prior arrangement’ (SP83).

Further, if an affirmative result is obtained in the determination of step SP83, the distributed data attribute generation unit 72 ends the distributed data attribute generation processing. If, on the other hand, a negative result is obtained in the determination of step SP83, the distributed data attribute generation unit 72 generates a new distributed data attribute and registers the generated distributed data attribute by adding same to the expanded distributed data attribute table 74 (SP84).

At this juncture, the newly generated distributed data attribute takes over the collection identifier, destination, and requirement/non-requirement for a collected data alternative storage notification for the collected data attribute which is associated with the distributed data attribute which was originally associated with the collected data (that is, the distributed data attribute which is associated in a case where the collected data was stored using a storage method according to the ‘prior arrangement’). Furthermore, the distribution target for the newly generated distributed data attribute is all the collected data.

Accordingly, the distributed data attribute generation unit 72 adds a record (row) for the newly generated distributed data attribute to the expanded distributed data attribute table 74 in step SP84, and stores the distribution identifier assigned to the newly generated distributed data attribute in the distribution identifier field 74A of this record. Further, the distributed data attribute generation unit 72 copies the information, which is stored in the collection identifier field 74B, destination field 74E and notification required/not required field 74F of the entry corresponding to the distributed data attribute which was originally associated with the collected data then serving as the target, to the collection identifier field 74B, destination field 74E and notification required/not required field 74F of this record respectively.

The distributed data attribute generation unit 72 also stores information to the effect that the storage method differs from the ‘prior arrangement’ in the storage method field 74C of the record added to the expanded distributed data attribute table 74 in step SP84 and copies the storage method which was registered in the corresponding processing field 54B in the collected data storage method definition table 54 (FIG. 4). In addition, the distributed data attribute generation unit 72 stores information, such as a character string or a code to the effect that all the collected data is the distribution target, in the distribution item field 74D of the record which was added to the expanded distributed data attribute table 74 in step SP84.

Thereafter, the distributed data attribute generation unit 72 determines whether or not the execution of the processing of steps SP83 and SP84 is complete for all the distributed data attributes specified in step SP81 (SP85). Further, if a negative result is obtained in this determination, the distributed data attribute generation unit 72 returns to step SP82 and subsequently repeats the processing of steps SP82 to SP85.

Further, if an affirmative result is obtained in step SP85 as a result of already completing the execution of the processing of steps SP83 and SP84 for all the distributed data attributes specified in step SP81, the distributed data attribute generation unit 72 ends the distributed data attribute generation processing.

### (3-2-2) Stored Data Retrieval Processing

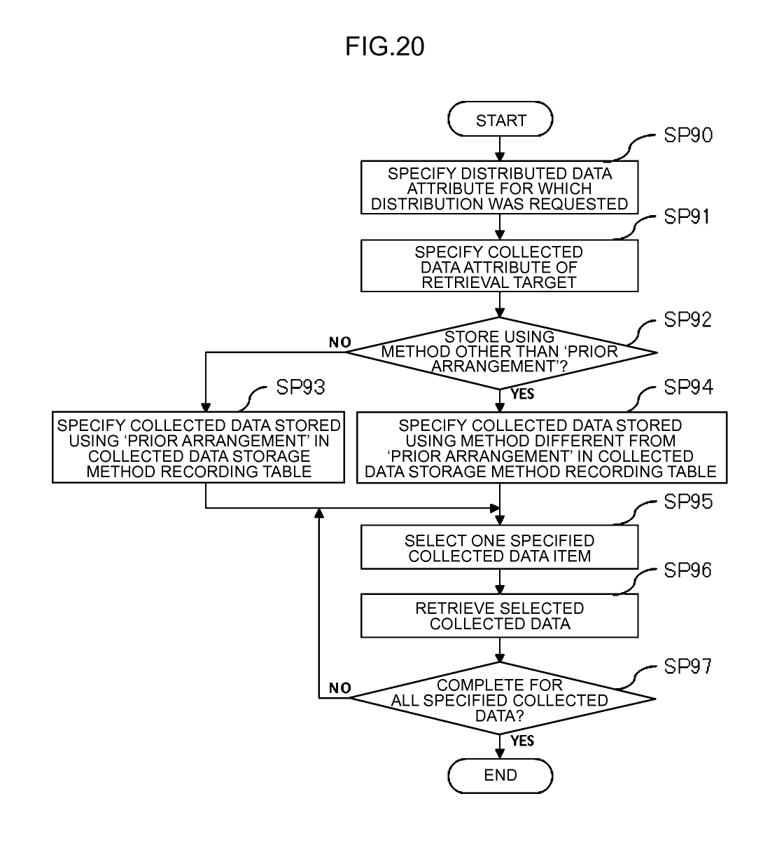

Meanwhile, FIG. 20 shows the processing content of the stored data retrieval processing which is executed by the expanded stored data retrieval unit 73 instead of the stored data retrieval unit 45 (FIG. 14) in step SP41 of the data distribution processing described hereinabove with reference to FIG. 11.

Upon starting the stored data retrieval processing, the expanded stored data retrieval unit 73 first specifies a distributed data attribute from the distribution identifier contained in the data distribution request (SP90), refers to the expanded distributed data attribute table 74 (FIG. 18) and specifies the collected data attribute of the collected data which is the retrieval target and which is associated with the specified distributed data attribute (SP91).

Subsequently, the expanded stored data retrieval unit 73 refers to the expanded distributed data attribute table 74 and determines whether or not the collected data which is the retrieval target specified in step SP91 was stored using the storage method according to the ‘prior arrangement’ (SP92).

Further, when an affirmative result is obtained in this determination, the expanded stored data retrieval unit 73 specifies the collected data, which was stored using a storage method which differs from the ‘prior arrangement,’ among the collected data belonging to the collected data attribute specified in step SP91, in the collected data storage method recording table 55 (SP93). If, on the other hand, a negative result is obtained in the determination of step SP, the expanded stored data retrieval unit 73 specifies collected data which was stored using the storage method according to the ‘prior arrangement’ among the collected data belonging to the collected data attribute specified in step SP91, in the collected data storage method recording table 55 (SP94).

The expanded stored data retrieval unit 73 then selects one collected data item among the collected data specified in step SP93 or SP94 (SP95) and retrieves the selected collected data from the collected data storage unit 50 or collected data alternative storage unit 51 in the secondary memory device 23 (SP96).

Furthermore, the expanded stored data retrieval unit 73 determines whether or not the execution of the processing of step SP96 is complete for all the collected data specified in step SP93 or SP94 (SP97). Further, if a negative result is obtained in this determination, the expanded stored data retrieval unit 73 returns to step SP95 and subsequently repeats the processing of steps SP95 to SP97 while sequentially switching the collected data selected in step SP95 to unprocessed collected data.

Furthermore, if an affirmative result is obtained in step SP97 as a result of already completing the retrieval, from the collected data storage unit 50 or collected data alternative storage unit 51, of all the collected data which was specified in step SP93 or SP94, the expanded stored data retrieval unit 73 ends the stored data retrieval processing.

Note that, subsequently, in the collected data alternative storage notification processing (FIG. 16) which is executed by the collected data alternative storage notification unit 75, when the collected data alternative storage notification is transmitted to the corresponding data destination client 6 in step SP75, the distribution identifier of the distributed data attribute which was newly generated in the foregoing stored data retrieval processing is also included in the collected data alternative storage notification and transmitted to the data destination client 6.

Therefore, the data destination client 6, which receives the distribution identifier that is associated with the newly generated distributed data attribute, transmits the data distribution request including the distribution identifier to the mediation server 71 in cases where transmission of the collected data associated with the new data distribution attribute is desirable.

### (3-3) Advantageous Effects of Embodiment

As described hereinabove, in the data collection and distribution system 70 according to this embodiment, in cases where the collected data is stored in the collected data alternative storage unit 51, the mediation server 71 manages this collected data in association with the new distributed data attribute and notifies the corresponding data destination client 6 of the fact that this collected data is stored in the collected data alternative storage unit 51 and of the new distributed data attribute associated with this collected data. Further, the mediation server 71 transmits the collected data which is associated with the distributed data attribute to the data destination client 6 in response to the data distribution request designating this distributed data attribute.

Accordingly, with this data collection and distribution system 70, as per the second embodiment, it is possible to shorten the time until the data user 30 is able to use collected data whose format has been changed due to collected data format changes at the convenience of the data provider 10, and therefore, in addition to the effects obtained by the first embodiment, this data collection and distribution system 70 also affords the effect of enabling the convenience of the data user to be improved.

### (4) Fourth Embodiment

### (4-1) Configuration of Data Collection and Distribution System According to this Embodiment

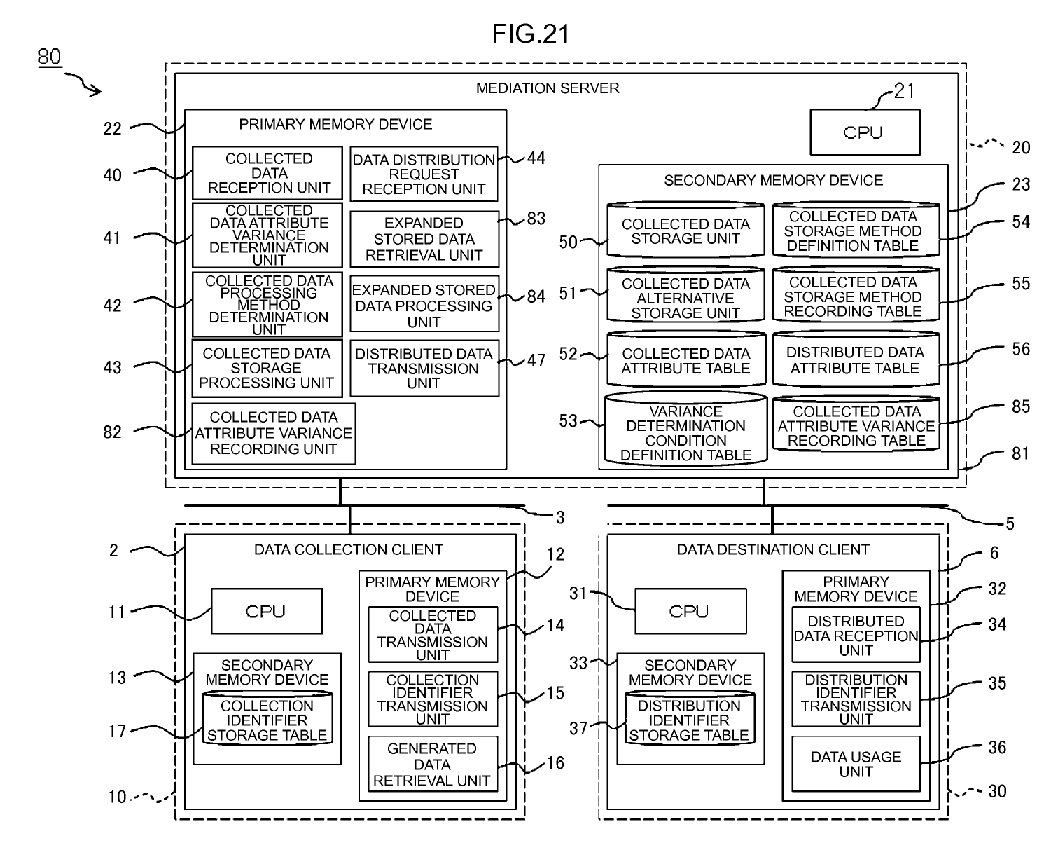

FIG. 21, which is shown having the same reference signs assigned to corresponding parts as FIG. 1, shows a data collection and distribution system 80 according to a fourth embodiment. This data collection and distribution system 80 is configured in the same way as the data collection and distribution system 1 according to the first embodiment except that a second expanded data distribution function is installed on a mediation server 81.

Here, the second expanded data distribution function is a function which distributes collected data to the corresponding data destination client 6 in cases where the data length satisfies the ‘prior arrangement’ and where the format of each item of the distribution target satisfies the ‘prior arrangement,’ even in cases where the format or the like of all the collected data which has been transmitted from the data collection client 2 differs from the ‘prior arrangement’ between the data provider 10 and data exchange intermediary 20.

As means for realizing this second expanded data distribution function, the primary memory device 22 of the mediation server 81 stores a collected data attribute variance recording unit 82 in addition to the collected data reception unit 40, the collected data attribute variance determination unit 41, the collected data processing method determination unit 42, the collected data storage processing unit 43, the data distribution request reception unit 44 and the distributed data transmission unit 47. Furthermore, the primary memory device 22 of the mediation server 81 stores an expanded stored data retrieval unit 83 and an expanded stored data processing unit 84 instead of the stored data retrieval unit 45 (FIG. 1) and stored data processing unit 46 (FIG. 1) respectively and the secondary memory device 23 of the mediation server 81 stores a collected data attribute variance recording table 85.

The collected data attribute variance recording unit 82 is a program comprising a function which, after the collected data attribute variance determination processing (FIG. 8) by the collected data attribute variance determination unit 41 is complete, determines whether or not the data length and format of each item, which are the detailed attributes of the collected data, are at variance with the ‘prior arrangement’ and records the determination result in the collected data attribute variance recording table 85 which will be described subsequently, concurrently with the collected data processing method determination processing (FIG. 9) which is executed by the collected data processing method determination unit 42.

In this case, the collected data attribute variance recording unit 82 refers to the collected data attribute table 52 (FIG. 2) to determine whether or not the format of each item is at variance with the ‘prior arrangement’ and extracts a data part which corresponds to the prescribed length from the start position of these items, and determines whether or not the format of each item is at variance with the ‘prior arrangement’ based on whether this data part represents a numerical value in the range prescribed for the item. For example, to determine whether or not the item ‘item #1’ in FIG. 2 is at variance with the ‘prior arrangement,’ a data part which corresponds to four bytes from the head of the payload portion of the collected data is extracted and a determination is made based on whether or not the extracted data part represents a numerical value in the range ‘0 to 100.’

Furthermore, the expanded stored data retrieval unit 83 is a program comprising a function which, in response to a data distribution request which is supplied from the data destination client 6, retrieves collected data corresponding to the distributed data attribute designated in the data distribution request from the secondary memory device 23. In this case, the stored data retrieval unit 45 according to the first embodiment retrieves only the collected data according to the ‘prior arrangement’ which is stored in the collected data storage unit 50 in the secondary memory device 23, whereas the expanded stored data retrieval unit 83 differs functionally from the stored data retrieval unit 45 according to the first embodiment in that the expanded stored data retrieval unit 83 retrieves not only collected data in the format or the like according to the ‘prior arrangement’ stored in the collected data storage unit 50 in the secondary memory device 23 but also collected data in a format or the like which differs from the ‘prior arrangement’ and which is stored in the collected data alternative storage unit 51 in the secondary memory device 23.

In addition, the expanded stored data processing unit 84 is a program comprising a function which, in cases where the data length and the format of each item of the distribution target, which are the detailed attributes of the collected data, satisfy the ‘prior arrangement,’ processes this collected data according to the ‘prior arrangement,’ not only for collected data in a format or the like according to the ‘prior arrangement’ which is stored in the collected data storage unit 50 in the secondary memory device 23 but also for collected data in a format or the like which differs from the ‘prior arrangement’ which is stored in the collected data alternative storage unit 51 in the secondary memory device 23.

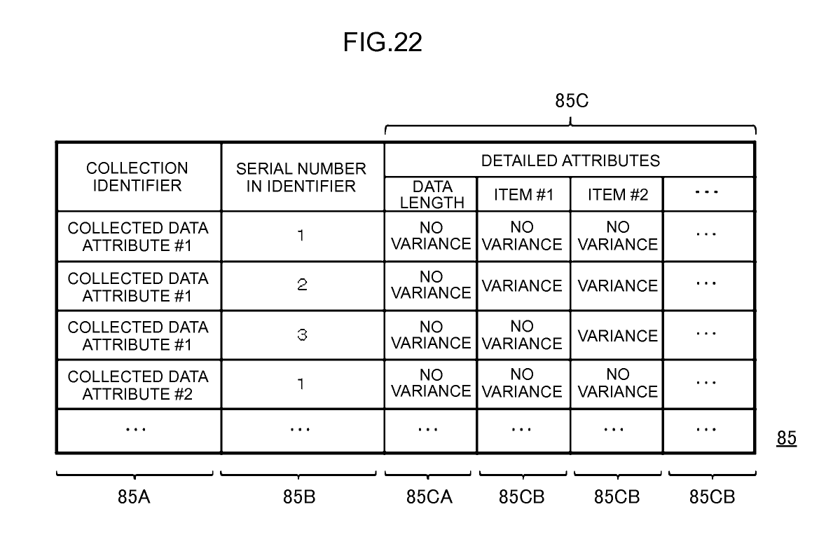

The collected data attribute variance recording table 85 is a table which is used to hold the result of the determination by the collected data attribute variance recording unit 82 regarding whether or not the data length and format of each item, which are the detailed attributes of the collected data, are at variance with the ‘prior arrangement,’ and, as shown in FIG. 22, is configured from a collection identifier field 85A, a serial number in identifier field 85B and a detailed attributes field 85C.

Further, the collection identifier field 85A stores collection identifiers of the collected data attributes to which the applicable collected data belongs and the serial number in identifier field 85B stores serial numbers in identifiers (see FIG. 5) which are assigned to the corresponding collected data.

Furthermore, the detailed attributes field 85C is configured from a data length field 85CA and a plurality of item fields 85CB which are associated with each of the respective items prescribed by the ‘prior arrangement.’ Further, the data length field 85CA stores the data lengths of the corresponding collected data, and the item fields 85CB each store information indicating whether or not the format of each of the corresponding items is at variance with the format of the ‘prior arrangement.’ More specifically, in cases where the format of a corresponding item in the corresponding collected data matches (is not at variance with) the format of the ‘prior arrangement,’ information to that effect (a character string, a code, or the like) is stored in the item fields 85CB, and in cases where the format of a corresponding item in the corresponding collected data does not match (is at variance with) the format of the ‘prior arrangement,’ information to that effect (a character string, a code, or the like) is stored in the item fields 85CB.

### (4-2) Various Processing which is Executed in Connection with the Second Expanded Data Distribution Function

### (4-2-1) Expanded Stored Data Retrieval Processing

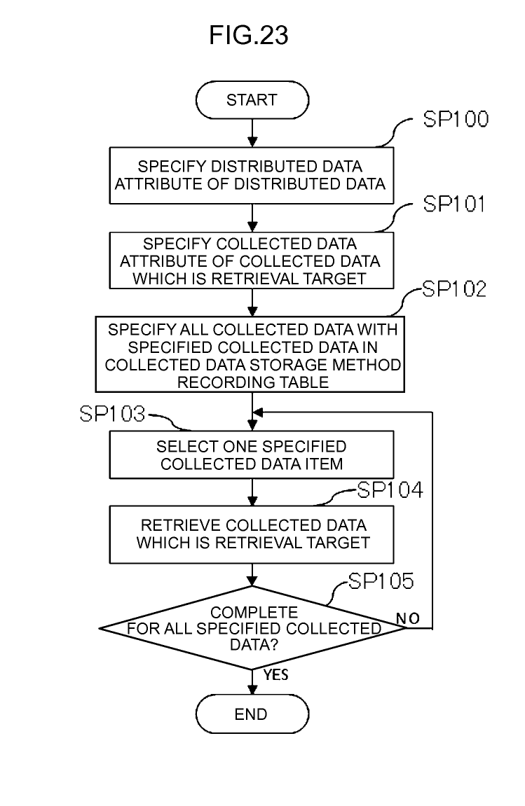

FIG. 23 shows a processing routine for the expanded stored data retrieval processing which is executed by the expanded stored data retrieval processing unit 83 instead of the stored data retrieval processing (FIG. 12) by the stored data retrieval unit 45 (FIG. 1) in step SP41 of the data distribution processing described hereinabove with reference to FIG. 11.

Upon starting the expanded stored data retrieval processing shown in FIG. 23, the expanded stored data retrieval unit 83 processes steps SP100 to SP103 in the same way as steps SP50 to SP53 of the stored data retrieval processing described hereinabove with reference to FIG. 12.

Thereafter, the expanded stored data retrieval unit 83 retrieves the collected data selected in step SP103 from the collected data storage unit 50 or collected data alternative storage unit 51 in the secondary memory device 23 (SP104) and subsequently determines whether or not the execution of the processing of step SP104 is complete for all the collected data specified in step SP102 (SP105).

If a negative result is obtained in this determination, the expanded stored data retrieval unit 83 returns to step SP103 and subsequently repeats the processing of steps SP103 to SP105 while sequentially switching the collected data which was selected in step SP103 to other unprocessed collected data.

Further, if an affirmative result is obtained in step SP105 as a result of already completing the execution of the processing of step SP104 for all the collected data specified in the collected data storage method recording table 55 in step SP102, the expanded stored data retrieval unit 83 ends the expanded stored data retrieval processing.

### (4-2-2) Processing to Process Expanded Stored Data

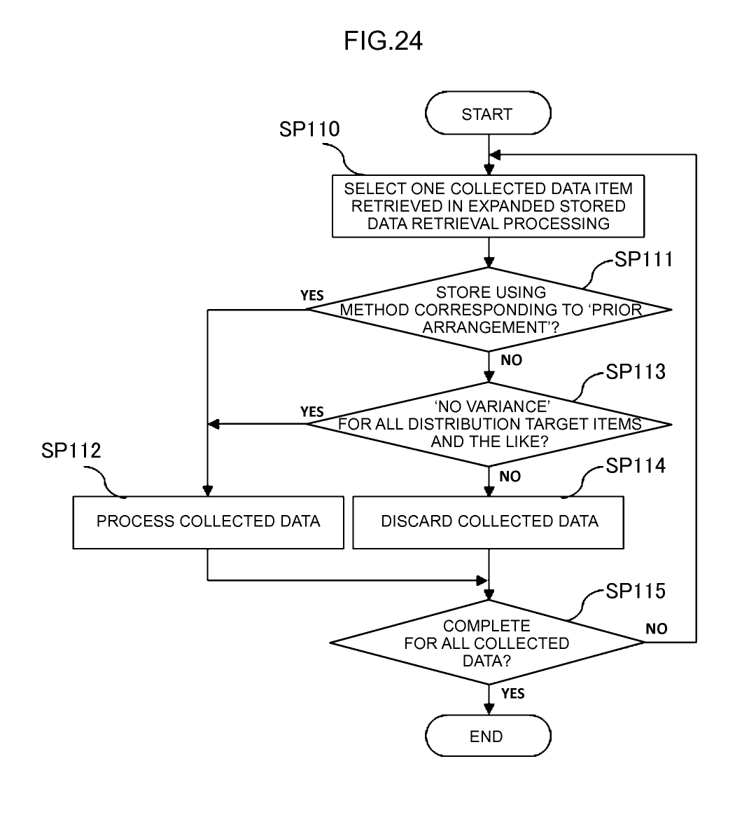

Meanwhile, FIG. 24 shows a processing routine for the processing to process expanded stored data which is executed by the expanded stored data processing unit 84 instead of the processing to process the stored data (FIG. 13) by the stored data processing unit 46 (FIG. 1) in step SP42 of the data distribution processing described hereinabove with reference to FIG. 11.

Upon starting the processing to process the expanded stored data shown in FIG. 24, the expanded stored data processing unit 84 first selects one collected data item which was retrieved from the collected data storage unit 50 or collected data alternative storage unit 51 in the foregoing expanded stored data retrieval processing (FIG. 23) (SP110).

Thereafter, the expanded stored data processing unit 84 determines whether or not the collected data selected in step SP110 was stored by the storage method according to the prior arrangement (that is, whether or not the collected data was stored in the collected data storage unit 50) (SP111).

If an affirmative result is obtained in this determination, the expanded stored data processing unit 84 refers to the distributed data attribute table 56 (FIG. 6) and executes the processing to process the format of the collected data then serving as the target to convert this collected data to the format according to the ‘prior arrangement’ with the data user (SP112), and then advances to step SP115.

If, on the other hand, a negative result is obtained in the determination of SP111, the expanded stored data processing unit 84 refers to the collected data attribute variance recording table 85 and determines whether or not the data length of the collected data and the format of all the items to be distributed to the data destination client 6 which was the source of the data distribution request satisfy the ‘prior arrangement’ (SP113).

If an affirmative result is obtained in this determination, the expanded stored data processing unit 84 refers to the distributed data attribute table 56 (FIG. 6) and executes the processing to process the format of the collected data then serving as the target to convert this collected data to the format according to the ‘prior arrangement’ with the data user (SP112), and subsequently advances to step SP115.

If, on the other hand, a negative result is obtained in the determination of step SP113, the expanded stored data processing unit 84 discards the collected data (SP114) and subsequently determines whether or not the execution of the processing of steps SP111 to SP114 is complete for all the collected data which was retrieved from the collected data storage unit 50 or collected data alternative storage unit 51 in the expanded stored data retrieval processing (FIG. 23) (SP115).

If a negative result is obtained in this determination, the expanded stored data processing unit 84 returns to step SP110 and subsequently repeats the processing of steps SP110 to SP115. Further, if an affirmative result is obtained in step SP115 as a result of already completing the execution of the processing of steps SP111 to SP114 for all the collected data retrieved from the collected data storage unit 50 or collected data alternative storage unit 51 in the expanded stored data retrieval processing (FIG. 23), the expanded stored data processing unit 84 ends the processing to process the expanded stored data.

### (4-3) Advantageous Effects of Embodiment

As described hereinabove, in the data collection and distribution system 80 according to this embodiment, the mediation server 81 distributes the collected data to the corresponding data destination client 6 in cases where the data length satisfies the ‘prior arrangement’ and the format of each item of the distribution target satisfies the ‘prior arrangement,’ even when the format or the like of all the collected data transmitted from the data collection client 2 differs from the ‘prior arrangement’ between the data provider 10 and the data exchange intermediary 20.

Therefore, with this data collection and distribution system 80, because a portion of the collected data, which is in a format or the like that differs from the ‘prior arrangement’ and which is not distributed by the data collection and distribution system 1 according to the first embodiment, is distributed from the mediation server 81 to the data destination client 6, the impact which updates to the data collection client 2 and data collection tests by the data provider 10 have on the data distribution from the mediation server 4 to the data destination client 6 can be reduced in comparison with the data collection and distribution system 1 according to the first embodiment.

Accordingly, in addition to the effects obtained by the first embodiment, the data collection and distribution system 80 also affords the effect of minimizing the impact, on the data user, of changes in the format or the like of the collected data at the convenience of the data provider 10.

### (5) Fifth Embodiment

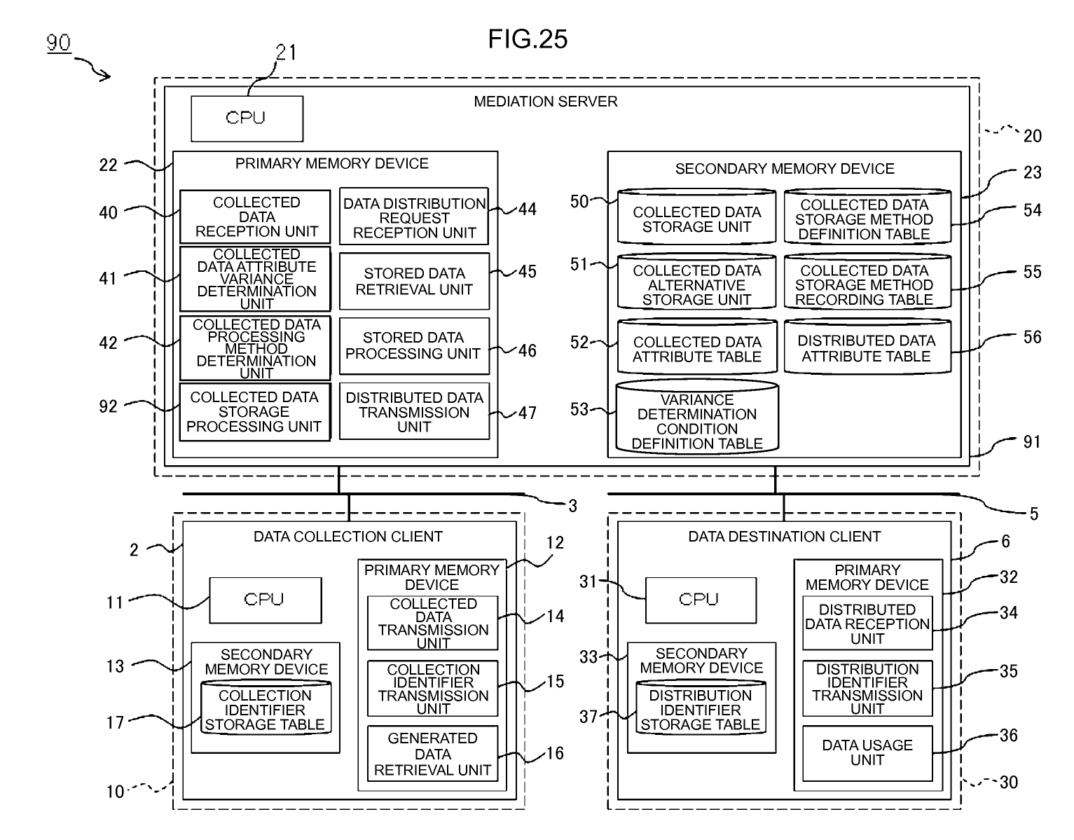

FIG. 25 shows a data collection and distribution system 90 according to a fifth embodiment. This data collection and distribution system 90 is configured in the same way as the data collection and distribution system 1 according to the first embodiment except for the fact that ‘discard data’ exists as one of the collected data processing methods which were determined by the collected data processing method determination unit 42, and that the processing content of the collected data storage processing which is executed by a collected data storage processing unit 92 of a mediation server 91 accordingly differs from the collected data storage processing unit 43 (FIG. 1) according to the first embodiment.

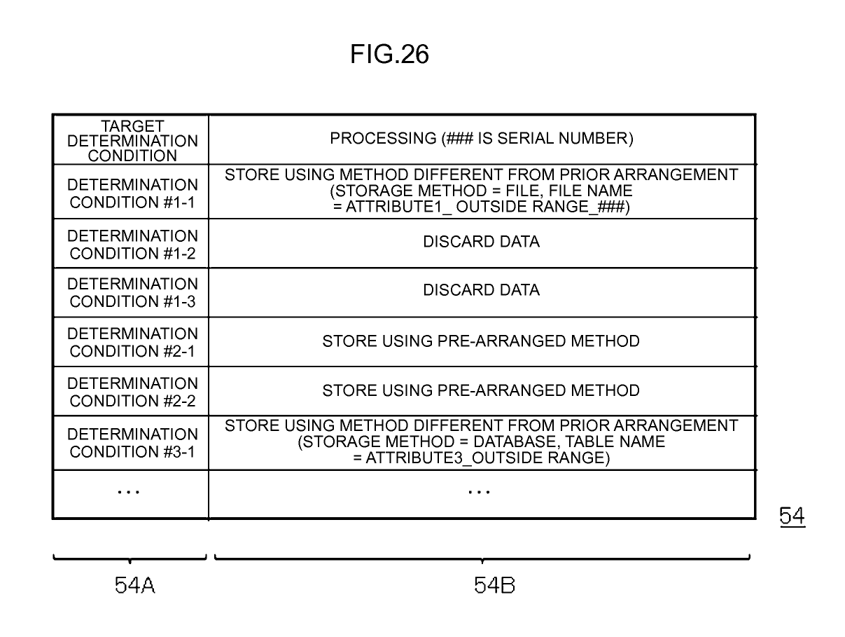

In reality, in the case of the data collection and distribution system 90 according to this embodiment, as shown in FIG. 26, a processing method referred to as ‘discard data’ is defined in the collected data processing method definition table 54 as one of the collected data processing methods for cases where the format or the like of the collected data is a format or the like which differs from the ‘prior arrangement.’

Further, in a case where the collected data processing method which is determined by the collected data processing method determination unit 42 was ‘discard data,’ the collected data storage processing unit 92 discards the collected data without storing same in the collected data alternative storage unit 51.

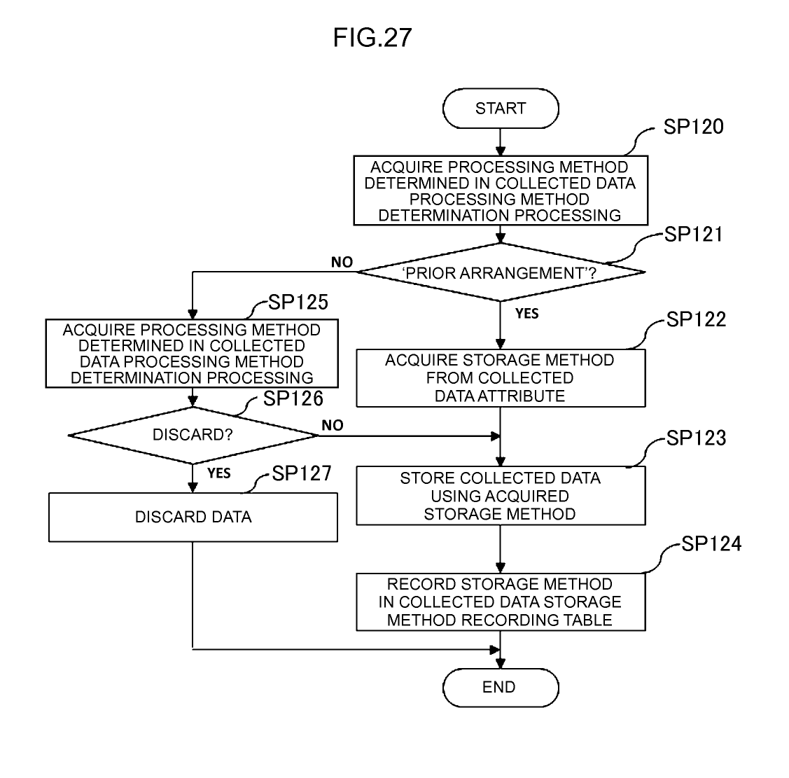

FIG. 27 shows collected data storage processing which is executed by the collected data storage processing unit 92 according to this embodiment instead of the collected data storage processing (FIG. 10) by the collected data storage processing unit 43 (FIG. 1) in step SP4 of the data collection processing described hereinabove with reference to FIG. 7.

Upon starting the collected data storage processing shown in FIG. 26, the collected data storage processing unit 92 according to this embodiment processes steps SP120 and SP121 in the same way as steps SP30 and SP31 of the collected data storage processing according to the first embodiment which was described hereinabove with reference to FIG. 10.

Further, if an affirmative result is obtained in the determination of step SP121, the collected data storage processing unit 92 processes steps SP122 to SP124 in the same way as steps SP33 to SP35 of the collected data storage processing according to the first embodiment described hereinabove with reference to FIG. 10 and subsequently ends the collected data storage processing.

If, on the other hand, a negative result is obtained in the determination of step SP121, the collected data storage processing unit 92 acquires the processing method determined in step SP23 by the collected data processing method determination processing described earlier with reference to FIG. 9 from the collected data storage method definition table 54 (FIG. 4) (SP125).

Thereafter, the collected data storage processing unit 92 determines whether or not the collected data processing method acquired in step SP125 is ‘discard data’ (SP126). Further, if a negative result is obtained in this determination, the collected data storage processing unit 92 advances to step SP123 and, after processing steps SP123 and SP124, subsequently ends the collected data storage processing.

If, on the other hand, a negative affirmative result is obtained in the determination of step SP126, the collected data storage processing unit 92 does not store the collected data in the collected data alternative storage unit 51, discards the collected data (SP127) and subsequently ends the collected data storage processing.

As described earlier, in the data collection and distribution system 90 according to this embodiment, since ‘discard data’ exists as one of the collected data processing methods which were determined by the collected data processing method determination unit 42, it is possible to effectively prevent unnecessary collected data from being stored in the collected data alternative storage unit 51 of the mediation server 91.

Accordingly, in addition to the effects obtained by the first embodiment, this data collection and distribution system 90 also affords the effect of making it possible to reduce the load of the mediation server 91 as a result of storing this unnecessary collected data in the collected data alternative storage unit 51 of the mediation server 91 and to effectively prevent an increase in the used capacity of the collected data alternative storage unit 51.

### (6) Further Embodiments

Note that, although a case was described in the foregoing first to fifth embodiments where a mediation server 4, 61, 71, 81, 91, which is a data collection and distribution apparatus which collects and stores collected data collected by the data collection client 2 and distributes the collected data to the data destination client 6, is configured as per FIGS. 1, 14, 17, 21 and 25 respectively, the present invention is not limited to such a case, rather, a variety of other configurations can be widely applied as the configurations of the mediation server 4, 61, 71, 81, 91 which is this data collection and distribution apparatus.

Moreover, although a case was described in the foregoing first to fifth embodiments where a collected data processing unit, which selectively distributes collected data in a format or the like according to the ‘prior arrangement’ to the data destination client 6 based on the result of the determination by the collected data processing method determination unit 42, is configured by the collected data storage processing unit 43, the data distribution request reception unit 44, the stored data retrieval unit 45, the stored data processing unit 46 and the distributed data transmission unit 47, and the like, the present invention is not limited to such a case, rather, a variety of other configurations can be widely applied as the configuration of this collected data processing unit.

### INDUSTRIAL APPLICABILITY

The present invention can be used in a data collection and distribution system which sends and receives data in a format according to a prior arrangement between a data provider and a data exchange intermediary, and between a data exchange intermediary and a data user.

### REFERENCE SIGNS LIST

1, 60, 70, 80, 90 Data collection and distribution system
2 Data collection client
4, 61, 71, 81, 91 Mediation server
6 Data destination client
21 CPU
22 Primary memory device
23 Secondary memory device
40 Collected data reception unit
41 Collected data attribute variance determination unit
42 Collected data processing method determination unit
43, 92 Collected data storage processing unit
44 Data distribution request reception unit
45 Stored data retrieval unit
46 Stored data processing unit
47 Distributed data transmission unit
50 Collected data storage unit
51 Collected data alternative storage unit
52 Collected data attribute table
53 Variance determination condition definition table
54 Collected data storage method definition table
55 Collected data storage method recording table
56, 63 Distributed data attribute table
62, 75 Collected data alternative storage notification unit
72 Distributed data attribute generation unit
73, 83 Expanded stored data retrieval unit
74 Expanded distributed data attribute table
75 Collected data alternative
82 Collected data attribute variance recording unit
84 Expanded stored data processing unit
85 Collected data attribute variance recording table

1. A data collection and distribution method for a data collection and distribution apparatus which acquires and stores collected data collected by a data collection client and distributes the collected data to a data destination client, comprising:
a first step in which the data collection and distribution apparatus determines whether or not an attribute of the collected data collected from the data collection client is at variance with an attribute according to a prior arrangement;
a second step in which the data collection and distribution apparatus determines a method for processing the collected data based on a determination result of the first step; and
a third step in which the data collection and distribution apparatus selectively distributes the collected data of the attribute according to the prior arrangement to the data destination client based on a determination result of the second step.

2. The data collection and distribution method according to claim 1,
wherein a data length for the collected data, a range which can be taken by a value contained in a specific position of the collected data, and a range and reception frequency for the data collection client which is a source of the collected data are prescribed by the prior arrangement as attributes of the collected data,
wherein, in the first step, the data collection and distribution apparatus determines whether or not a determination condition which is prescribed beforehand according to the prior arrangement and which relates to the attributes of the collected data is satisfied and whether or not attributes of the collected data are at variance with the attributes according to the prior arrangement,
wherein, in the second step, the data collection and distribution apparatus determines the collected data processing method to be a method according to the prior arrangement in cases where the attributes of the collected data are the attributes according to the prior arrangement, and determines the collected data processing method to be a method which differs from the prior arrangement in cases where the attributes of the collected data differ from the prior arrangement,
wherein, in the third step, for the collected data whose processing method was determined to be a method according to the prior arrangement, the data collection and distribution apparatus stores the collected data using a first storage method according to the prior arrangement, whereas for the collected data whose processing method was determined to be a method which differs from the prior arrangement, the data collection and distribution apparatus stores the collected data using a second storage method which differs from the prior arrangement, and
wherein the data collection and distribution apparatus selectively distributes the collected data stored using the first storage method to the data destination client.

3. The data collection and distribution method according to claim 1,
wherein, in the third step, the data collection and distribution apparatus processes the collected data stored using the first storage method to convert this collected data to a format according to the prior arrangement, and distributes the processed collected data to the data destination client.

4. The data collection and distribution method according to claim 1,
wherein, in the third step, the data collection and distribution apparatus notifies the data destination client of the fact that the collected data was stored using the second storage method in a case where the collected data was stored using the second storage method.

5. The data collection and distribution method according to claim 4,
wherein a plurality of attributes corresponding to the content of the collected data exist in the collected data,
wherein the data destination client designates an attribute of the collected data and issues a request to the data collection and distribution apparatus to distribute the collected data,
wherein the data collection and distribution apparatus selectively distributes the collected data, which was stored using the first storage method among the collected data which belongs to the requested attribute, to the data destination client,
wherein, in the second step, in a case where a method which differs from the prior arrangement is determined as the collected data processing method, the data collection and distribution apparatus generates a new attribute for the collected data which is associated with this method,
wherein, in the third step, the data collection and distribution apparatus notifies the data destination client of the fact that the collected data was stored using the second storage method and of the new attribute generated for this collected data, and
wherein the data collection and distribution apparatus distributes the collected data belonging to the new attribute to the data destination client in a case where a request from the data destination client to distribute the collected data for which the new attribute was designated is received.

6. The data collection and distribution method according to claim 2,
wherein, in the third step, the data collection and distribution apparatus distributes the collected data to the data destination client in a case where, despite being collected data of an attribute which differs from the prior arrangement, the data length of the collected data and the value contained in a specific position of the collected data are in an allowable range.

7. The data collection and distribution method according to claim 1,
wherein, in the third step, the data collection and distribution apparatus discards the collected data whose processing method was determined to be a method which differs from the prior arrangement.

8. A data collection and distribution apparatus which acquires and stores collected data collected by a data collection client and distributes the collected data to a data destination client, comprising:
a collected data attribute variance determination unit which determines whether or not an attribute of the collected data collected from the data collection client is at variance with an attribute according to a prior arrangement;
a collected data processing method determination unit which determines a method for processing the collected data based on a result of the determination by the collected data attribute variance determination unit; and
a collected data processing unit which selectively distributes the collected data of the attribute according to the prior arrangement to the data destination client based on a result of the determination by the collected data processing method determination unit.

9. A program executed by a data collection and distribution apparatus which acquires and stores collected data collected by a data collection client and distributes the collected data to a data destination client, the program causing the data collection and distribution apparatus to execute processing, comprising:
a first step of determining whether or not an attribute of the collected data collected from the data collection client is at variance with an attribute according to a prior arrangement;
a second step of determining a method for processing the collected data based on a determination result of the first step; and
a third step of selectively distributing the collected data of the attribute according to the prior arrangement to the data destination client based on a determination result of the second step.
